(19) United States
(12) Patent Application Publication
(10) Pub. No.: US 2013/0103768 A1
(43) Pub. Date: Apr. 25, 2013

(54) PHYSICIAN MOBILE COMMUNICATIONS SYSTEM AND METHOD

(71) Applicant: Peter Freebeck, La Grange, IL (US)

(72) Inventor: Peter Freebeck, La Grange, IL (US)

(21) Appl. No.: 13/279,951

(22) Filed: Oct. 24, 2011

(51) Int. Cl. G06F 15/16

(52) U.S. Cl. 709/206; 709/204

(57) ABSTRACT

The LynxIT Mobile System (LMS) provides efficient and economical communications solutions for healthcare professionals. The LMS provides physician to physician communication through mobile smartphone platforms, and rules, including role based rules that prevent unauthorized communications between users. The LMS interfaces with a paging system that provides paging services to the facilities, healthcare professionals, including physicians. The LMS and paging system may interface with staff directories and on-call schedules for hospitals and healthcare facilities accessible through a network. The LMS uses a staff directory and on-call schedule request service that communicates a request to accessible staff directories and on-call schedules for hospitals, healthcare professionals, and other healthcare facilities. The LMS and SPS ingest the directories returned from the request. In this way, physicians control communications between themselves and other healthcare professionals, and create private communications channels based on physician defined rules.

### BACKGROUND OF THE INVENTION

1. Technical Field

This disclosure concerns systems, and methods for communications. In particular, this disclosure relates to an efficient and economical approach to providing physicians control of configurable secure communications between the physician and other healthcare professionals, including flexible paging communications.

2. Background Information

Healthcare service providers (e.g., physicians, psychologists, nurse practitioners, physician assistants, and therapists) are in constant demand and seek the most optimized resource utilization levels to improve patient care. Many healthcare facilities use traditional systems and methods to communicate inefficiently and ineffectively among the various healthcare professionals available to the facility and staff. Traditional communications systems and methods provide no way for physicians to be included in staff communication and paging systems while allowing the physician to control communications directly with other physicians. Using traditional communications systems and methods, Physicians have no way of securely controlling and/or excluding other roles of healthcare professionals, including for example non-physicians (e.g., nurse, clerk, facility), from contacting the physicians directly, according to the physician's preferences.

Currently, when a primary care physician (pcp) requests a consult with another physician, a nurse calls an answering service for the consul physician with the consult request, the answering service attempts to page or call the consult physician, when the consult physician is unavailable, which is expected when operating at optimal resource utilization level, the consult physician calls back the answering service and the original message is relayed. After the series of communication relays, the nurse and the primary care physician may be unavailable to communicate with the consult physician. Traditional communications systems and methods introduce unnecessary delays and ultimately impact patient care due to untimely diagnoses and delayed physician input.

A need has long existed for a system and method to efficiently and economically provide physicians control of configurable secure communications between the physician and other healthcare professionals, including flexible paging communications.

### SUMMARY

The LynxIT system configuration provides a system and method for delivering physician-to-physician communications. The LynxIT system configuration includes a LynxIT mobile system (LMS) that provides the physician-to-physician communications. The LMS and other LynxIT system configuration components communicate using a network (e.g., the Internet). The LMS registers users and stores the registrations in a memory coupled to a processor. The memory includes registration requests for various users (e.g., physicians or some other category or combination of users based on rules and user roles) to use an application accessible on the network. The memory also includes user registration identifiers for the users (e.g., a license number or professional identifier), validation status information for user registration identifiers, and entity identifiers for entities (e.g., hospitals and other healthcare facilities) where the users are licensed to practice. The memory further includes a user communication status selection selected by a first user through the user interface, a communications request from a second user requesting to communicate with the first user. The LMS memory includes instructions (e.g., LMS logic) executable by the processor that when executed by the processor cause the processor to validate the user registration identifiers, and compare the communications request from the second user with the communication status selection of the first user. When the communications request satisfies the communication status selection, the LMS provides a communications method to use between the first user and the second user, according to the communication status selection of the first user. The LMS logic may be distributed to operate and be executed by multiple processors, including the processor on the mobile device of the user (e.g., as the client device) in communications with a LMS server. The registration identifier may identify a license to practice and specializations for the user. When the communications request of the second user does not satisfy the communication status selection of the first user, the LMS provides the second user an alternative user (a third user) to select for communications. The second user may be permitted to communicate with the third user when the communication status selection of the alternative user is compatible with the communications request of the second user.

The LynxIT Mobile system (LMS) maybe implemented as a smart-phone or other smart-device based the LMS, which facilitates direct, inter-physician communications. For example, the LMS may be implemented on the following device types and platforms: Windows™ Mobile; iPhone™; Android™; and Blackberry. LynxIT Mobile system (LMS) may operate with the LynxIT Solutions' Smart Paging System (SPS), which may provide a database configuration for the LMS.

Other systems, methods, and features of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the invention.

Moreover, in the figures, like referenced numerals designate corresponding parts or elements throughout the different views.

FIG. 1 shows a LynxIT system configuration.

FIG. 2 shows a LynxIT mobile system (LMS) application icon as presented on a mobile device.

FIG. 3 shows a LynxIT system startup presentation page.

FIG. 4 shows a login page to log into the LMS application.

FIG. 5 shows a LMS search for doctor page.

FIG. 6 shows a View Doctor page of a selected unavailable physician's contact information.

FIG. 7 shows a View Doctor page of an available physician's contact information with specialty and a comment listed.

FIG. 8 shows a physician's my status page and scheduled override in place message.

FIG. 9 shows another physician's my status page.

FIG. 10 shows a physician's override options page for a first and second hospital.

FIG. 11 shows a physician's my status page with the ‘update’ message displayed and the ‘my status’ page with the update complete.

FIG. 12 shows a logic flow diagram for the LynxIT mobile system.

FIG. 13 shows a database schema with entity relationships used by the LMS.

FIG. 14 shows tables defined in the database schema.

FIG. 15 shows other tables defined in the database schema.

FIG. 16 shows other tables defined in the database schema.

FIG. 17 shows a login page to log into the LMS application with the save password option.

FIG. 18 shows a provider filters page hospital and physician specialty selections.

FIG. 19 shows a physician search results page.

FIG. 20 shows an unavailable physician selected from the search results page.

FIG. 21 shows an available physician selected from the search results page.

FIG. 22 shows a physician's my status page status and the use schedule option selected.

FIG. 23 shows a physician's my status page with the override to available selected.

FIG. 24 shows a physician's my status page with call guard option on.

FIG. 25 shows a physician's my status page when the call guard option is toggled from on to off.

FIG. 26 shows a physician's ‘my status’ page override selection and resulting ‘my status’ page.

FIG. 27 shows an ‘available schedule override’ page with comment field.

FIG. 28 shows a selected unavailable physician's contact information page selected from the search results list.

FIG. 29 shows an alternative physician for selection on the selected unavailable physician's contact information page.

FIG. 30 shows a physician's on-call status with call guard on.

FIG. 31 shows a smart paging system (SPS) configuration.

FIG. 32 shows SPS communications features.

FIG. 33 shows a user's (Health facility) message dashboard.

FIG. 34 shows a ‘create message’ page for a physician not accepting pages.

FIG. 35 shows a ‘create message’ page for a consult.

FIG. 36 shows a ‘close message’ page for a consult.

FIG. 37 shows a ‘create message’ page for a physician accepting pages.

FIG. 38 shows a user's (Health facility) message dashboard.

### DETAILED DESCRIPTION

The LynxIT mobile system (LMS) configuration provides a mobile clinician to clinician networked application that facilitates direct communications between physicians based on the physician's availability preferences. The LynxIT mobile system provides direct physician to physician communications, finds and connects to another physician based on the other physician's availability, and searches for physicians based on hospital and specialty. The LMS includes changes to the physician's on-call schedule, provides communication to healthcare professionals using text messaging, paging and voice services, works with all major phone carriers, and works on various mobile device platforms, including iPhone™, Windows™ mobile, Android™ and Blackberry™ platforms. The mobile solution provides physician to physician communication, promotes direct clinician communication, facilitates timely decision-making, reduces duplicate and unnecessary testing when alternative physicians are available to provide unlimited options so that workflow is uninterrupted and delivery of service improves patient care and throughput is optimized.

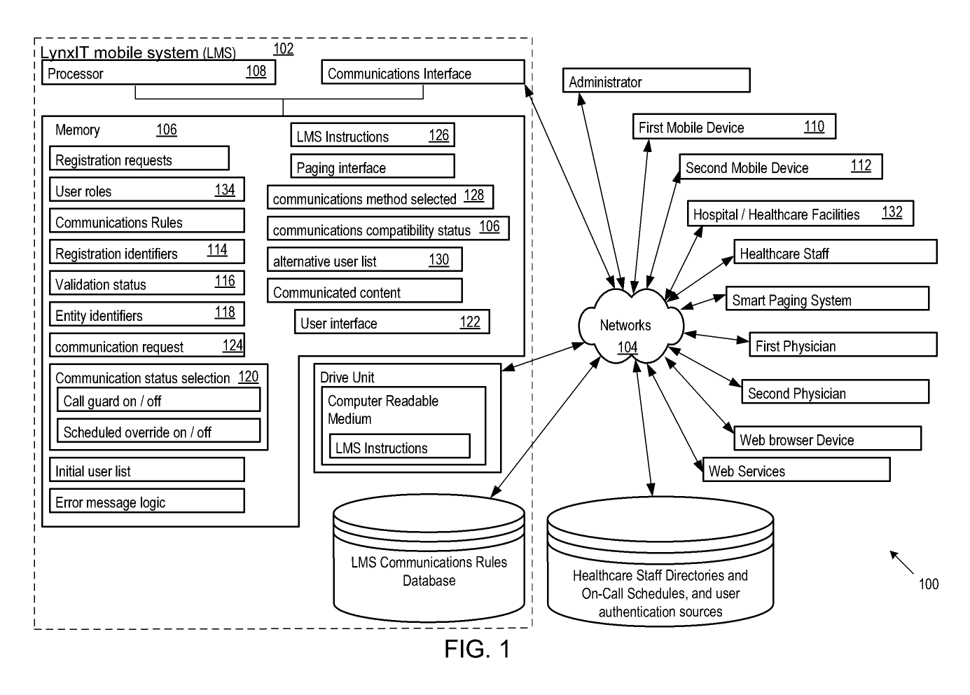

FIG. 1 shows a LynxIT system configuration 100. The LynxIT system configuration 100 includes the LMS 102 that provides physician to physician communication. The LMS and other LynxIT system configuration components (e.g., smart paging system discussed below) communicate using a network 104 (e.g., the Internet). The LMS 102 includes a memory 106 coupled to a processor 108, and the memory 106 includes registration requests for various users (110 and 112 mobile devices used by the users) (e.g., physicians or some other category or combination of users based on rules and user roles), to use the LMS application accessible on the network 104 in order for the user to configure communication. The memory 106 also includes user registration identifiers 114 for the users (e.g., a license number or professional identifier), validation status 116 information for the user registration identifiers 114, and entity identifiers 118 for entities (e.g., hospitals and other healthcare facilities) where the users are licensed to practice. The memory 106 further includes a user communication status selection 120 selected by a first user through the user interface 122, a communications request 124 from a second user requesting to communicate with the first user. The LMS memory 106 includes instructions 126 (e.g., LMS logic) executable by the processor 108 that when executed by the processor 108 cause the processor 108 to validate the user registration identifiers 114, compare the communications request 124 from the second user with the communication status selection 120 of the first user, and when the communications request 124 satisfies and/or is compatible with the communication status selection 120, the LMS 102 provides a communications method 128 to use between the first user and the second user, according to the communication status selection 120 of the first user. The LMS 126 logic may be distributed to operate and the LMS logic may be executed by multiple processors, including the processor on the mobile device (110 and 112) of the user (e.g., as the client device) in communications with the LMS 102. The registration identifier 114 may identify a license to practice and specializations for the user. When the communications request 124 of the second user does not satisfy the communication status selection 120 of the first user, the LMS provides the second user an alternative user 130 (a third user) to select for communications. The second user may be permitted to communicate with the third user when the communication status selection of the alternative user 130 is compatible with the communications request 124 of the second user. The LMS 102 validates the registration identifier 114, which includes authenticating the user registration identifier 114 by comparing the registration identifier 114 with one or more user authentication sources accessible through the network 104, and communicating a validation result indicator (e.g., validation status) that indicates whether the registration identifier 114 is valid. The LMS 102 retrieves entity identifiers 118 from one or more accessible staff directories for hospitals and other healthcare facilities 132. The entities comprise hospitals and other healthcare facilities 132. The LMS 102 stores each of the entity identifiers 118 for the entities that correspond to the validated user, and may store identifier information (e.g., user authentication, and entity identifiers) on a mobile device (110 and 112) used by the user. The mobile device is configured to communicate audio and visual communications through the LMS user interface for user interaction. The LMS provides the user the configurable communication status selection 120 that indicates the type of communication (e.g., communications method 128) the user is willing to receive, including for example, text messaging, an email, and phone calls. The user communication status selection 120 may also indicate the type of communication 128 the user is willing to receive based on the role 134 of the requester requesting the communications (e.g., a physician will only accept calls from the physician's office or another physician, but not a clerk or nurse).

The LynxIT Mobile system provides for various users (110 and 112 mobile devices used by the users) (e.g., physicians or some other category or combination of users based on rules and user roles). The LMS 102 provides each of the various users (110 and 112 mobile devices used by the users) a classification (status) used to restrict/allow calls based on user configurable rules. For example, the doctor classification may be assigned #1, the nurse supervisor classification may be assigned #2, the clerk classification #3, and the pharmacist classification #4. When a user enrolls, the user sets up rules or allowances available for the user's defined classifications.

Table 1 shows an example of Physician “A” user's rules set up. The rules provides that Physician “A” allows contact from all classes, and Class #1 (doctors) have full access without being filtered by a schedule that indicates the doctor's availability, but other classes (e.g., classes #2 and #3) are configured to use a schedule filter and only have access to Physician “A” if Physician “A” sets their availability as such. Table 1 shows that for the Physician “A” example class #2 (Nurse supervisor) can call direct by phone, whereas Class #3 must use text-pager.

TABLE 1
Example Physician “A” user's rules set up

| | | Class #2 | |
|---|---|---|---|
| | Class #1 | (Nurse | Class #3 |
| Rule | (physicians) | supervisor) | (Clerk) |
| Define if allows any contact at all from | Yes | Yes | Yes |
| Class | | | |
| Allows contact using schedule | Yes | Yes | Yes |
| Allow contact, doesn't require using | Yes | No | No |
| schedule filter | | | |
| Contact method allowed | Text, page | Pager | Pager |
| | only, voice | | |

Table 2 shows methods of contact by time period the users may schedule.

TABLE 2
Methods of Contact by Time Period

| Time | Contact method |
|---|---|
| 8am-5pm | Phone |
| 5pm-10pm | Pager-text only |
| 10pm-8am | Answer service only |

The LMS 102 provides a confirmation of callbacks with metric reporting and an alarm notifier. The LMS 102 also provides a dashboard for each user, based on user sign on, that tracks when a call/page was sent, time stamps when the call/page was sent, and when callbacks occur, the callback may be identified (e.g., checked box) as closed with time stamp recorded. The LMS 102 provides reports for metrics that identify the time elapsed for callbacks to occur, and whether callbacks even occur. The LMS 102 further provides a notification alarm that a user may set when the user expects a callback to occur based on a call-page class. For example, the user may set stat callbacks for 15 minutes so that LMS alarms if the callback does not occur within the 15 minutes scheduled, or the user may set routine callbacks for 60 minutes, so that LMS alarms if a callback does not occur within 60 minutes.

The LynxIT Mobile system processes at least two types of errors that may occur for a user while using the system, including: failure to complete a particular communication with a web service (e.g., potentially the result of poor phone signal, or due to an outage in the LynxIT data center) within a reasonable amount of time; and 2) an internal error (e.g., a web application server responded, but could not successfully complete the request). In order to address the first error, the system may set a timeout parameter on the mobile clients to 50 seconds, to allow for slow cellular data connections. When a timeout occurs, the system displays a message indicating that there was a timeout, with a configurable and user selectable option to retry the last action. When a server error occurs, the application displays a message such as the following example: “Error in http request, received status code <HTTP status code received from server>.” The system may use the information to diagnose problems when the system logic is operational in production.

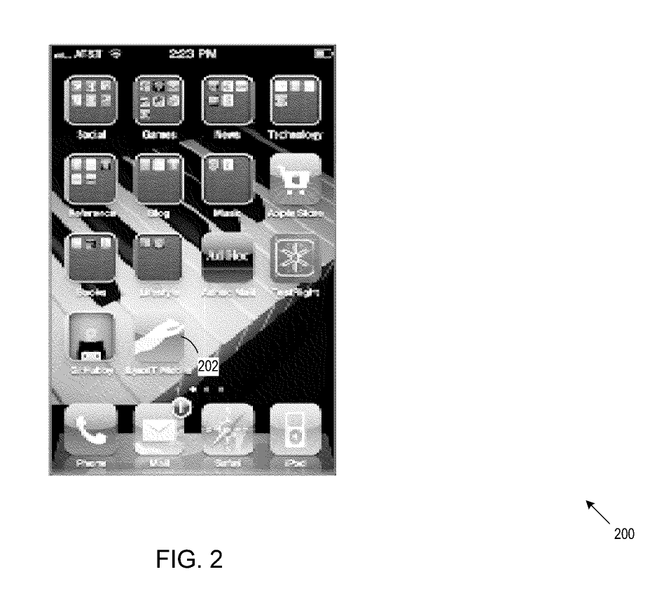

FIG. 2 shows a LynxIT mobile system (LMS) 102 application icon 202 as presented on a mobile device (110 and 112). The user selects the LMS application icon 202 or button to log into the LMS application. When a user first launches the LynxIT mobile application (e.g. the system logic 126 may not be already resident in memory of the client side mobile device 110 and 112). The system 102 provides a user selectable icon, (e.g., titled “LynxIT Mobile”, using a standard icon across various mobile device platforms), selectable according to the conventions of the specific device (e.g., on iPhone™ or Android™ phone by selecting (tapping) on the application icon from a home screen).

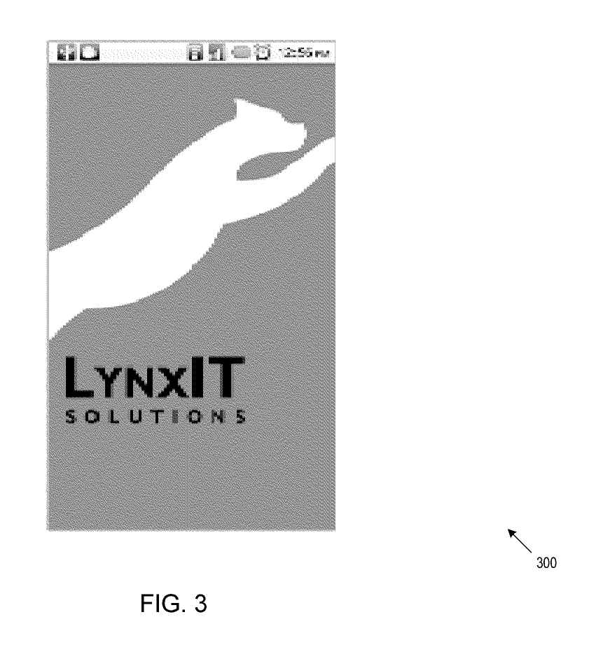

FIG. 3 shows a LynxIT system startup presentation page 300 the LMS 102 may present while the LMS application prepares to initiate interaction with the user. Upon initial load (e.g., when the system logic 126 is not already resident in memory but currently inactive), the system logic 126 presents a LynxIT Solutions splash page 300, and subsequently the login page.

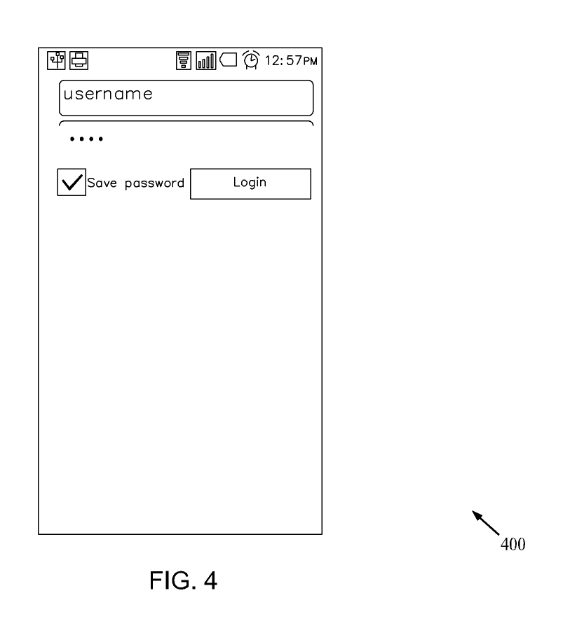

FIG. 4 shows a login page to log into the LMS application. The system logic prompts the user to enter his/her credentials, which the system logic passes to a LynxIT service for validation. Although in one implementation, the system does not establish a user session on the system server, the system logic calls the LynxIT service for validation, and stores locally on the mobile device (client side), the user ID and password which the system logic appends to subsequent server calls. When the user selects the option (icon or button) to log into the system, the system may display a visual indication that the login is in progress (e.g., a spinner, “Please wait . . . ”, etc.). When authentication is successful, control is automatically passed to the Doctor Search page discussed below. When authentication is unsuccessful, the system may continue to present the user the login page through the user interface, and an appropriate message is displayed (e.g. “Login unsuccessful—please check user ID and password and try again.”). For example, the “save password” widget (a checkbox on Android, slider on a iPhone™) defaults to enabled/yes. When enabled, the system remembers (e.g., saves the password in permanent storage on the device). The user name and password may optionally be defaulted in the fields the corresponding fields when the “Login” is button or option is selected, and subsequently thereafter populate the Login fields automatically with those values.

For ease of administration and/or user preference, the system logic makes use of username prefixes to allow the administrator and/or user to specify an environment (e.g., ‘t’ for test, ‘tr’ for training, ‘p’ for production) to access. Each prefix may map to a specific base URI (uniform resource identifier) for the web services with which the system logic communicates. The prefix and subsequent user ID may be delimited by either a forward or backward slash (the system logic recognizes and may accept either). Prefixes may be identified as case insensitive, the system logic may optionally convert case to all lower or upper (depending on how the URI's are mapped) so case does not matter from the user's perspective. When no prefix is entered, the system logic may recognize the environment as production or a configurable alternative environment. When a prefix is entered that is not in a list of known configurable prefixes, the system logic may default to the production URI and attempt to login with the credentials provided.

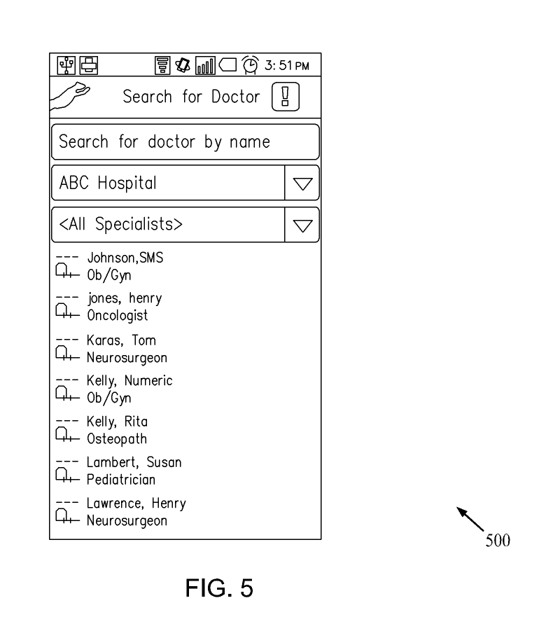

FIG. 5 shows a LMS search for doctor page. Post the login page, the system logic may subsequently present a search page, where a user (a doctor) can find (another) doctors within one or more hospitals, and optionally filter for a particular specialty. When a hospital is selected, a search is initiated. When a specialty is selected, the search is re-initiated. While a search is processed, there a visual indicator that indicates that the system logic is searching (spinner, “please wait . . . ”, etc.) for the requested information. The system logic “remembers” the Hospital from previous usage and defaults when the search page is displayed. The system logic may store the last-selected hospital to a permanent local storage so that the last-selected hospital is retained, even when the mobile device memory is flushed or when only the last-selected hospital is flushed from the mobile device memory. The system logic may default to <All Specialties> when the page is first displayed after starting system logic on the mobile device. When the page is reached by navigating “back” from another page of the system user interface, system logic retains the specialty and search results previously displayed. The list may be in ascending order by last name. However, the names may be arranged ordered in a number of alternative ways. The system allows the user to quickly find a specific doctor in a list of search results. On the Windows and Android phones, the “type-ahead filter” (the field with the label “Search for doctor by name” in the screen shot above; typing into this field will locally filter the doctor list for names with a matching character sequence. On the iPhone, an “index strip” (letters A-Z down the right side of the display) is used instead.

Table 3 shows platform difference that LMS is adapted to execute on.

TABLE 3
Platform Differences

| Feature | iPhone | Android | BlackBerry |
|---|---|---|---|
| Format of | No icon. Doctor | Standard Android | No icon; single |
| doctor and | name, bold type, | contact icon. | line per doctor. |
| specialty in | first line; | Doctor name, bold | Format |
| search | specialty on | type, first line; | <LastName>, |
| results | second line. | specialty on | <FirstName> - |
| | | second line. | Specialty |
| Mechanism | Uses index bar | Type-to-filter field | Type-to-filter field |
| for quickly | on right side of | at the top of the | at the top of the |
| finding a | display | page | page |
| doctor in | | | |
| the search | | | |
| results list | | | |

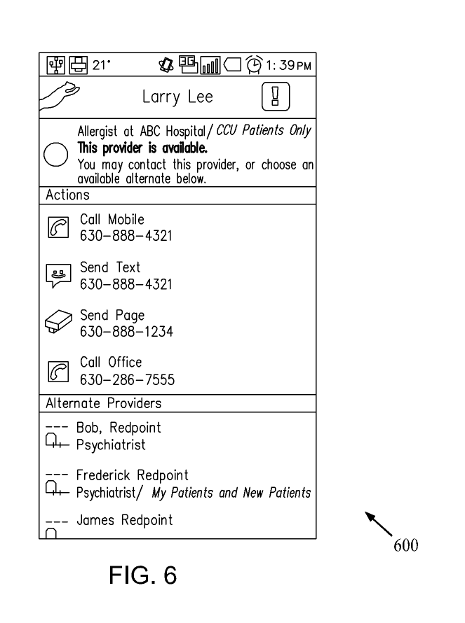

FIG. 6 shows a View Doctor page of a selected unavailable physician's contact information. The View Doctor page, a user may initiate contact (e.g., call, text or page) with the doctor, or select an alternate doctor to select. When an alternate doctor is selected, the system logic displays a new view Doctor page in which the selected alternate doctor is the main subject, with the rules, features and behavior working the same way, but based on the alternate doctor's information. From the search results page, a user can tap on a doctor to call up the View Doctor page. The View Doctor page indicates to the user whether the doctor is or is not currently available, communicates and presents the various ways to contact that doctor, and also provides a list of available alternates (e.g., other doctors within the currently selected doctor's practice who are currently available). On the View Doctor page, a user may initiate contact (e.g., call, text or page) with the doctor, or select an alternate doctor. When an alternate doctor is selected, the system logic displays a new view Doctor page in which the selected alternate doctor is presented as the main subject, with the rules, features and behavior working the same way, but based on the alternate doctor's information.

From the search results page, a user may select a doctor for whom the system logic retrieves the information and presents the information on the View Doctor page. The View Doctor page indicates to the user whether the selected doctor is or is not currently available, lists the method to communicate with and/or contact that doctor, and provides a list of available alternate doctors (e.g., other doctors within this doctor's practice who are currently available). For example the system logic may use data, and exhibit the following behaviour to present a doctor's information on the View Doctor page. The doctor's name appears on the first line, in a larger font (relative to other text on the page). When the doctor is available, an availability indicator, such as a green-ball icon is displayed. When the doctor is unavailable, the system logic may display the availability indicator as a red-ball icon. Beneath the doctor's name, a second line displays the doctor's specialty, and when the doctor is available (on call) and has on-call schedule comments, displayed as well. The system logic may use a general format to specify the doctor's specialty and on-call status, for example, “Specialty/on-call comments” (note separating sash, and italicized comments). Beneath the specialty and comments line, a textual indicator of availability appears, for example: This provider is available. (in green), or This provider is not available. (in red). After the Available/Not Available text, the following message appears: “You may contact this provider, or choose an available alternate below.”

The system logic presents two sections: Actions; and Alternate Providers. The system logic populates alternate providers section based on the availability of other providers within the same practice as the doctor whose page is currently displayed (the system logic may use a particular web service call to retrieve these alternate doctors). When calling the service to retrieve alternate doctors, the user is prompted to provide a practice identifier (e.g., practice ID) that belongs to the doctor whose name appears at the top of the page. When the doctor presented at the top of the page is currently on call, the system includes the doctor in the results returned by the web service. The doctor may be manually removed from the list. For each alternate provider (doctor) in the list of alternates, the system presents the doctor name (in bold), and beneath the doctor's name, a line containing specialty and on-call comments (e.g., slash-delimited, with comments in italic—same format as used in the page header for the doctor we are currently viewing). The system may present the “Alternate Doctors” section heading on this page, optionally even when there are no available alternate doctors. Selecting (e.g., touch screen tapping) on an alternate provider the system presents a new instance of the View Doctor page with the selected alternate doctor as the chosen doctor. The system presents a “back” button for the user to return to the previously-selected doctor. When an alternate doctor is selected, that alternate doctor may in turn have other alternate doctors. The system logic provides a way to search and drill into many alternate providers in succession. The system logic optionally provides a way for the user to navigate (backward or forward) to a particular list of alternates retrieved and directly navigate to the originally presented doctor. When the user navigates to the originally selected doctor the system logic may direct the user to the Search Results page.

The system may provide various contact actions (e.g., contact options) that the user may select to contact or be contacted. The system logic populates the actions section based on phone numbers returned from a search for the selected doctor. Actions will appear when the corresponding phone number is populated (e.g., returned by the data retrieval service call). The system presents the call mobile option when the mobile number for a doctor is present, and when the user selects (e.g., tapping a touch screen surface) the mobile number entry, the system calls a LynxIT service (e.g., the system logic may implement an action to fire a trigger/stored procedure to log the contact action) to log the contact, and then launch the phone application and dial the number. The system presents the call office option when the office number for the doctor is present. When the user selects (e.g., tapping a touch screen surface) the entry the system calls the LynxIT service (e.g., fire and forget) to log the contact, and launches or initiates execution of the phone application and dials the number. The system presents the call answering service option, when the answering service number is present. When the user selects (e.g., tapping) this entry the system calls a LynxIT service (e.g., fire and forget) to log the contact, and then launch the phone application and dial the number. Send Page: appears when pager number is present; tapping this entry will call a LynxIT service (fire and forget) to log the contact, and then launch the phone application and dial the number. The system may present the send text option, when the mobile number is present. When the user selects (e.g., taps) this entry the system logic calls a LynxIT service (fire and forget) to log the contact, and then launch the SMS using the mobile number. In addition to initiating the desired form of contact (e.g., call, page, text), each of the actions also causes the system to call a LynxIT web service that logs the contact event.

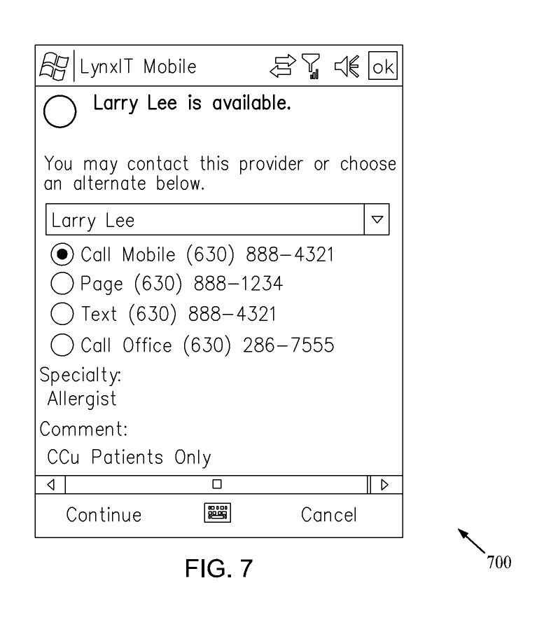

FIG. 7 shows an available physician's contact information with specialty and a comment listed on a BlackBerry™. Because of tighter hardware constraints (smaller screen size, etc.), particular mobile devices (e.g., BlackBerry™), the system logic may be adapted to mimic the Windows™ Mobile 6 application, wherein selecting (e.g., tapping a touch screen surface) a doctor in the list causes the system to display a page that may show: The name of the doctor, with availability status—either “<name> is available.” in green, or “<name> is not available.” in red. An instructional sentence that reads exactly the same as the Windows Mobile example: “You may contact this provider or choose an alternate below.” A dropdown list box containing the selected doctor and any available alternates. A list of contact options for the person selected in the dropdown. The system presents the contact options similarly for each mobile device platform (e.g., BlackBerry, iPhone, and Android). The retrieved list of phone numbers is a dynamic list, when there is no phone number in a specific field, the system logic may suppress the option. The ‘Call Mobile’ and ‘Text’ options may be presented to the user based on the same mobile number field. Beneath the contact options, the system may display the specialty and comment (from the schedule entry, when present), as shown in the Windows™ Mobile example as shown.

The system logic adapts for the BlackBerry mobile device, the contact options may not be radio buttons, but a list of BlackBerry UI widgets that convey that clicking or selecting one of the presented options initiate an action—not merely select it. The BlackBerry app will not have Continue and Cancel buttons (as the Windows Mobile app does), so clicking on a contact action will trigger an immediate response. Because we won't have a Cancel button in the BlackBerry app, it should have some sort of ‘Back’ button that navigates back to the Search page. In the iPhone app, this is in the title bar (as per convention on iPhone), and on Android it's the hardware back button common to all Android phones (and thus not visible in screen shots). On BlackBerry we should follow the typical convention on that platform for navigating back one page.

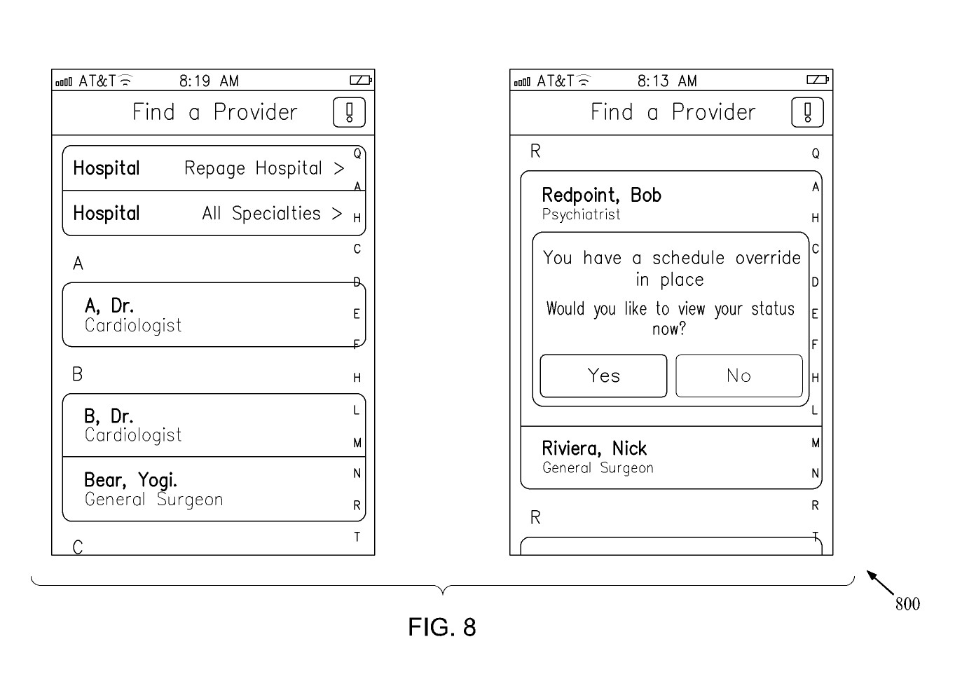

FIG. 8 shows a physician's my status page and scheduled override in place message. When a user (doctor) wants to view the user's own current on-call status at the applicable hospitals, the action used to call up the My Status page may adapt to the particular phone platform the user is using (e.g., iPhone, Android, Blackberry). From the system main Search/Results page, the user selects (clicks) the ‘menu’ button on the phone, and the ‘My Status’ button. Using the Android platform, when the user has a schedule override currently in place, a schedule override indicator (e.g., exclamation point) appears on the application title bar, in the upper right corner. The system may present the system application/logic title in the title bar to the user on all pages. The user may select (tap) the indicator, which will bring up a dialog with the message, “You have a schedule override in place. Would you like to view your status now?”. The system logic presents buttons that allow the user to proceed (selecting the Yes option), or simply clear the dialog and navigate to the main Search/Results page (selecting the No option). Using the iPhone and/or BlackBerry platform, the system logic presents a button on the title bar (e.g., upper right corner) and an exclamation point, when a schedule override currently exists. Optionally, the system logic presents a different icon when no override is currently scheduled. When the user selects (taps) the title bar button, when no override currently exists the system logic presents the My Status page. When the user selects (taps) the title bar button when an override exists (e.g., when the system presents an exclamation point with red background) the system displays the alert dialog, from which the user may proceed to the My Status page or navigate to another page.

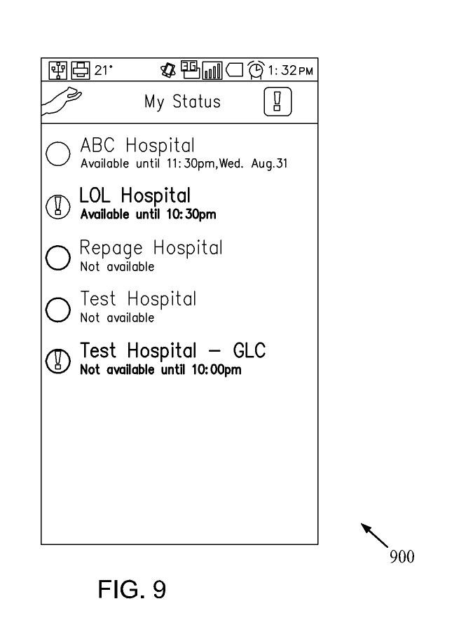

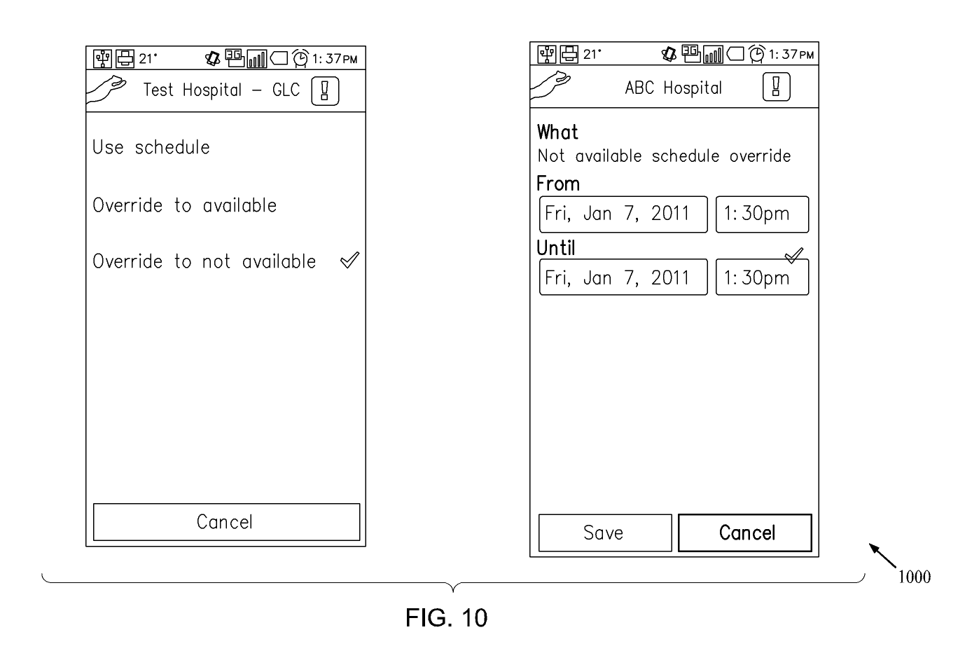

FIG. 9 shows another physician's my status page. The system logic presents the My Status page to the user and indicates where the user is currently on or off call (e.g., indicated by green and red icons), as well as indicates where the user currently has a schedule override in place (e.g., indicated by an exclamation point ‘!’ as the icon or some other visual indicator). The system application and corresponding web application provide the user (doctor) a standard schedule that defines when the doctor is scheduled on call at each hospital where the doctor typically has rounds. The system provides a schedule override that defines a segment of time, bounded by specific dates and times, during which a doctor is either on call or not on call, as an exception to the user's normal schedule. The system may allow the user to schedule one override at a time for each hospital. The My Status page content includes a list of hospitals with the doctor's status at each hospital displayed. When the doctor is currently on call according to the standard schedule, and no overrides exist for the doctor, the system logic may display a visual indicator (e.g., a solid green-ball icon) to indicate on call availability, and a message line displayed (e.g., beneath the hospital name) that may include the text “On call until <end date/time of scheduled on call period>”. When the doctor is currently not on call according to the standard schedule, and no overrides exist for the doctor, the system logic may display a visual indicator (e.g., a solid red-ball icon) to indicate no on call availability, and a message line displayed that includes an “Off call” message. When the doctor is currently on call at a hospital and a schedule override exists for the doctor for that hospital, a green-ball-with-exclamation icon may be displayed to indicate on call availability for the doctor, and a message line displayed that includes “On call until <end date/time of override entry>”. When the doctor is not currently on call at a hospital and a schedule override exists for that hospital, a red-ball-with-exclamation icon is displayed, and the message line may include “Off call.” When a schedule override exists for a doctor for a hospital, and that schedule override is currently active (e.g., “now” falls between the start and end date-times of the override), then the system logic displays the hospital name and corresponding message, in boldface or some combination of fonts and color, and/or some combination of visual indicators, to indicate on call availability. The system dynamically formats the end date/time values. For example, when the current date, show only time: e.g. “until 10:00 pm”, when within 7 days of current date, show weekday name: e.g. “until 10:00 pm Wednesday”, otherwise, show time, abbreviated weekday name, and date: e.g. “until 10:00 pm Wed August 31”.

FIG. 10 shows a physician's override options page for a first and second hospital. When a doctor views the doctor's own availability by hospital on the My Status page, the doctor may modify the doctor's own availability at a hospital, either by adding or removing a schedule override. The user selects (taps) the entry for a hospital, the system presents the user a selection dialog with three choices: 1) Use schedule: delete any schedule override, when one exists, for this hospital, and use my default schedule; 2) override on call: create a schedule override for this hospital that represents a span of time I am on call, in exception to the standard schedule; and 3) override off call: create a schedule override for this hospital that represents a span of time I am not on call, in exception to the standard schedule. When the user selects (taps) on one of the options, the system processes the selection. When the user does not make a change, the user may select the Cancel button (e.g., on iPhone, Back button) to return to the My Status page. When the user selects to use the schedule, the system logic calls a LynxIT web service to remove any existing schedule override for the user at the indicated hospital. The system logic redisplays the My Status page to the user, and system logic updates the entry for the affected hospital. When the override on call is selected, the system logic presents the user a page to enter a From and Until date/time values for the override. When an existing on-call override exists at the chosen hospital, the system logic presents the user the From and Until date/time values for the existing override. Otherwise, the system defaults the From and until to the current time. When an override exists, but the override is an off-call override, the system logic defaults the From and Until values to the current time, not to the start and end times of the existing override. When the override off call is selected the system logic presents the user a page to enter the From and Until date/time values. When an off-call override exists for the chosen hospital, the system logic defaults the From and Until date/time values to the values associated with the existing override. Otherwise, the system logic defaults the From and Until values to the current time. When an override exists, but the override is an on-call override, the system logic defaults the From and Until to current time, rather than defaulting to the start and end times of the existing override.

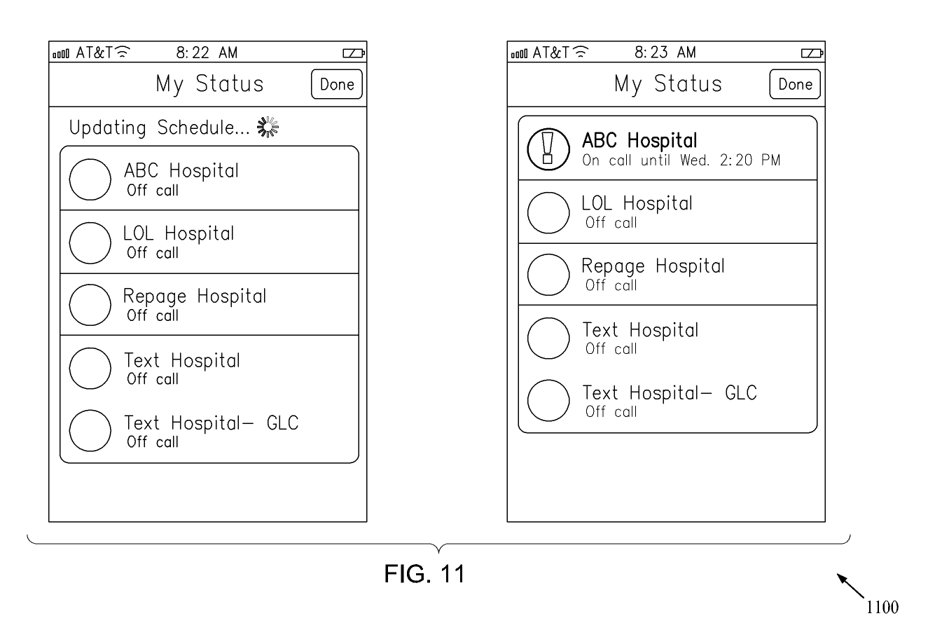

FIG. 11 shows a physician's my status page with the ‘update’ message displayed and the ‘my status’ page with the update complete. The system provides the doctor a way to create schedule overrides for Date/Time selections. The system provides on the date/time selection page, the user selectable and/or enterable date/time values such that a valid time span is represented (e.g., Until must fall after From date/time). When the user attempts to save with an Until date/time equal to or earlier than From date/time, the system logic may display an error message and remain on the page so the user may resolve the error. The user may select (tap) the Cancel option or selection to abort the schedule override. The system may adapt to use user interface “widgets” native to the phone platform (e.g., for example where the widgets are different on each phone platform and/or operating system) to enter date and time. The user may select (tap) an existing date/time value to call up a date/time entry dialog, modify the date/time value, and select (click) a button to return to the page showing the From and Until values. When the user specifies a valid override time span, and the user selects (taps) the Save button, the system logic calls a LynxIT service that establishes the schedule override, using the entered date/time values, and the “direction” (e.g., on-call or off-call) obtained previously when the user selected (tapped) either Override on call or Override off call. The system logic navigates to the My Status page, and the entry for the affected hospital is updated to reflect the change. The system may immediately navigate to the My Status page with an indication that the system is refreshing the screen. The iPhone screen example shows the My Status page a) immediately after saving a schedule override, pre-refresh, and b) after the refresh/redraw is complete.

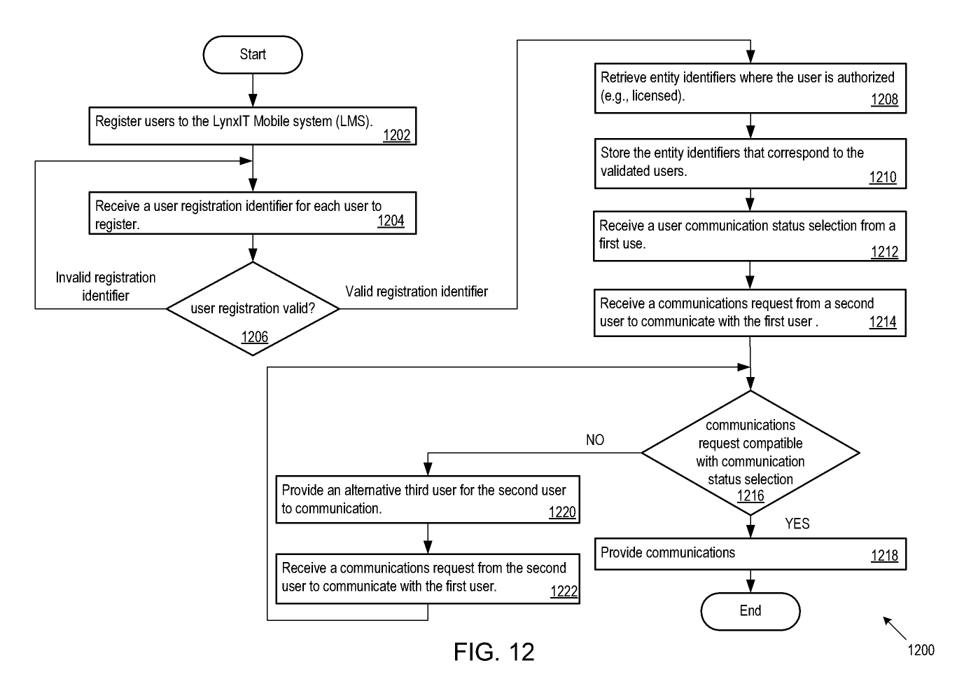

FIG. 12 shows a logic flow diagram 1200 for the LynxIT mobile system 102. The LMS 102 registers users, including a first user and a second user, to use the LMS application accessible on a network (e.g., the Internet). The LMS receives a user registration identifier for the users (1202, 1204), validates the user registration identifiers (1206), and retrieves entity identifiers for entities where the users are licensed to practice (1208). The LMS 102 stores each of the entity identifiers for the entities that correspond to the validated users (1210). When the first user selects a first user communication status selection (e.g., call guard on) for the first user, the LMS 102 stores the first user communication status selection (1212). When the LMS receives a communications request from the second user requesting to communicate with the first user (1214), the LMS compares the communications request from the second user with the communication status selection of the first user (1216). When the communications request satisfies the communication status selection (1218), the LMS provides a communications method to use between the first user and the second user, according to the communication status selection of the first user. The registration identifier 114 may identify a license to practice and specializations for the user. When the communications request of the second user does not satisfy the communication status selection of the first user, the LMS provides the second user an alternative user to select for communications (1220). The alternative user communication status selection is compared for compatibility with the communications request of the second user (1222 and 1216). The LMS validates the registration identifier by authenticating the user registration identifier by comparing the registration identifier with one or more user authentication sources accessible through the network. The LMS 102 communicates a validation result indicator that indicates whether the registration identifier is valid. The entity identifiers are retrieved from accessible staff directories for hospitals and other healthcare facilities, where the entities comprise hospitals and other healthcare facilities. The LMS 102 stores each of the entity identifiers that correspond to the validated user, and may store the identifier on the mobile device used by the user. The mobile device may be configured to communicate audio and visual communications. The user communication status selection indicates the type of communication the user is willing to receive, including: text messaging; an email; and phone call. The user communication status selection may also indicate the type of communication the user is willing to receive based on the role of the requester requesting the communications.

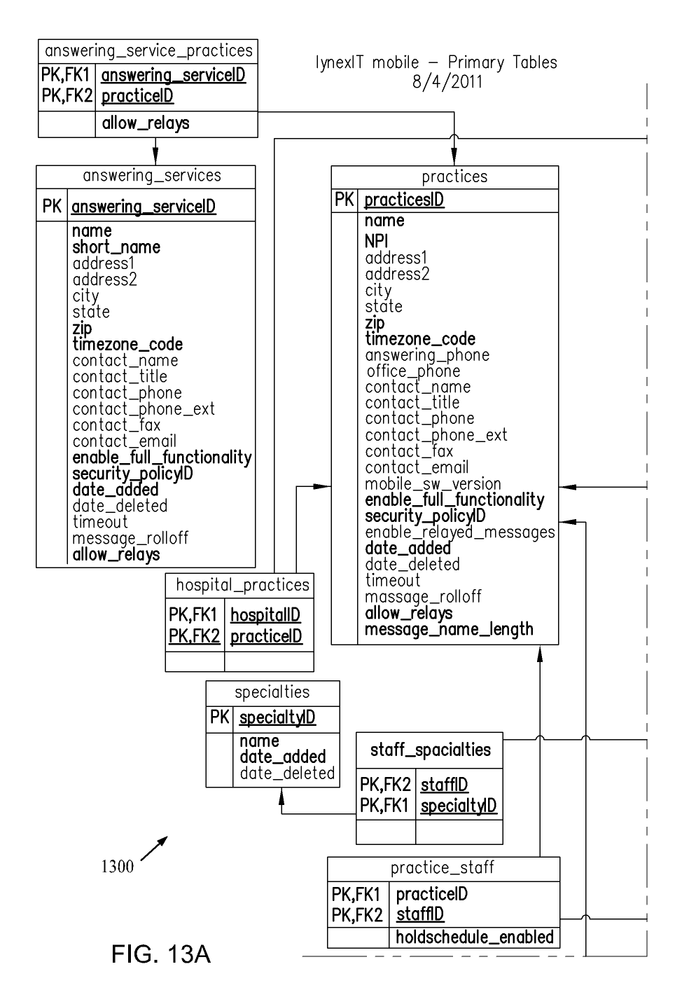

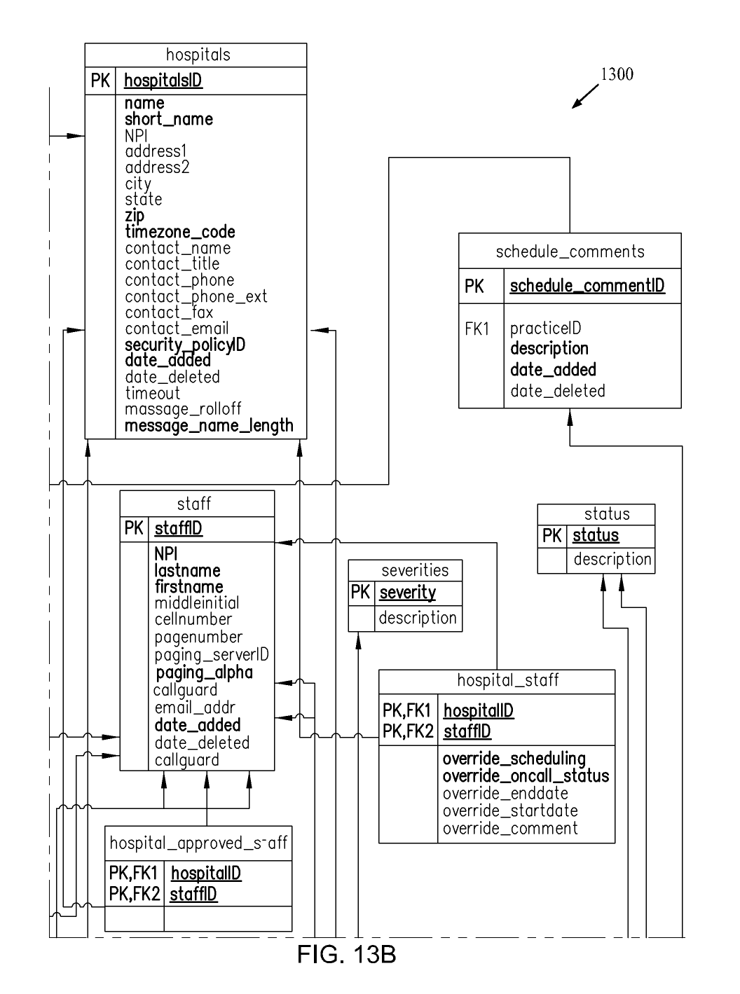

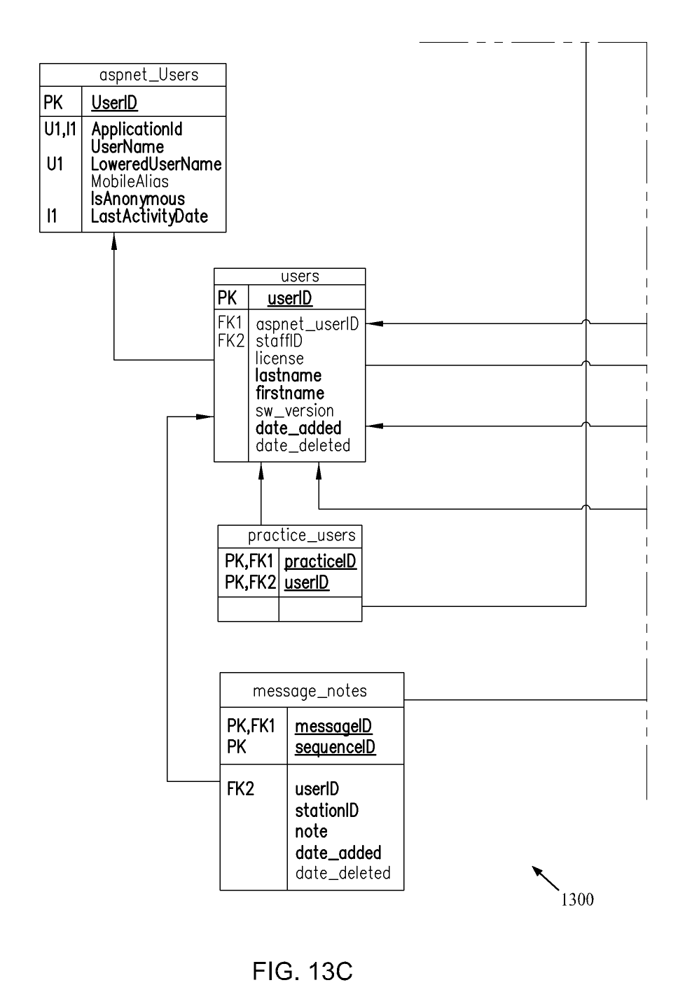

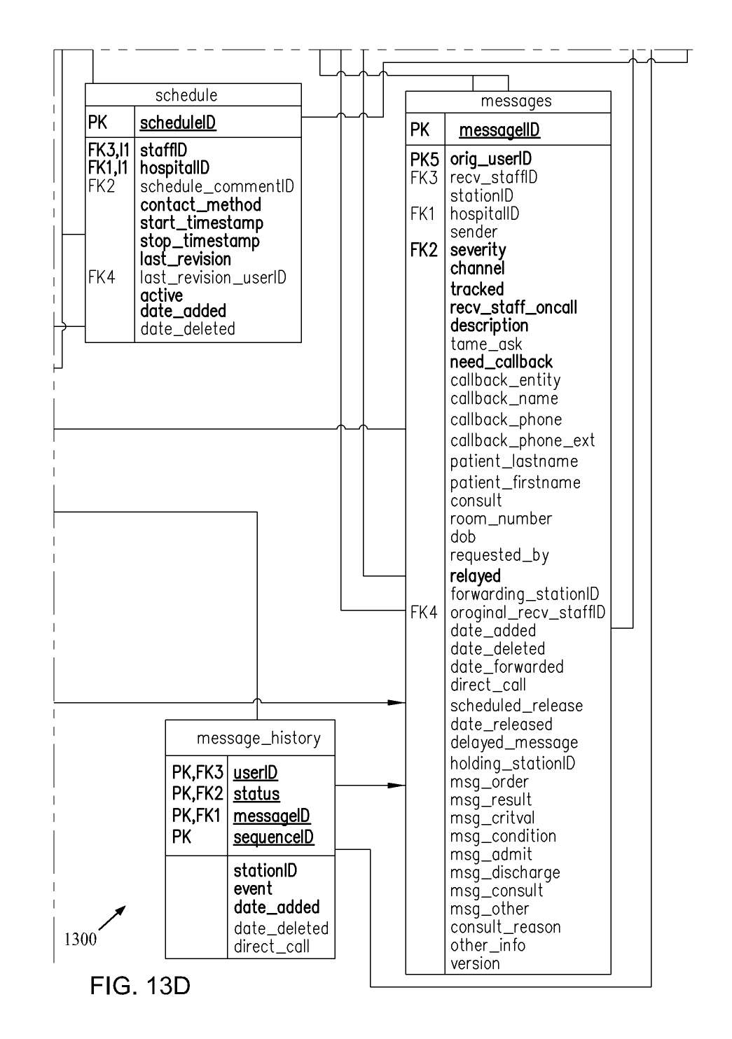

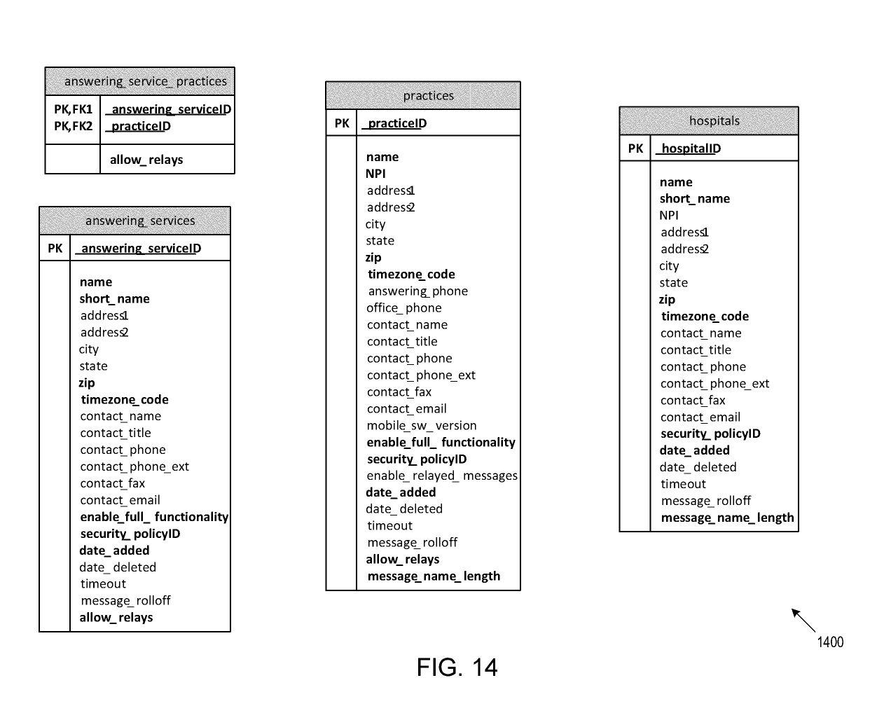

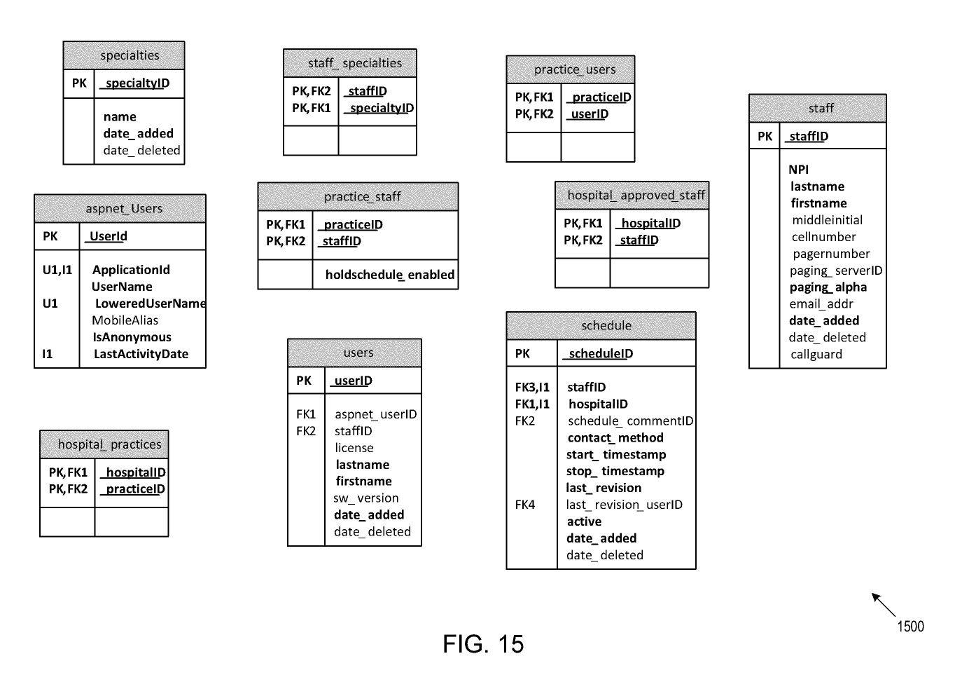

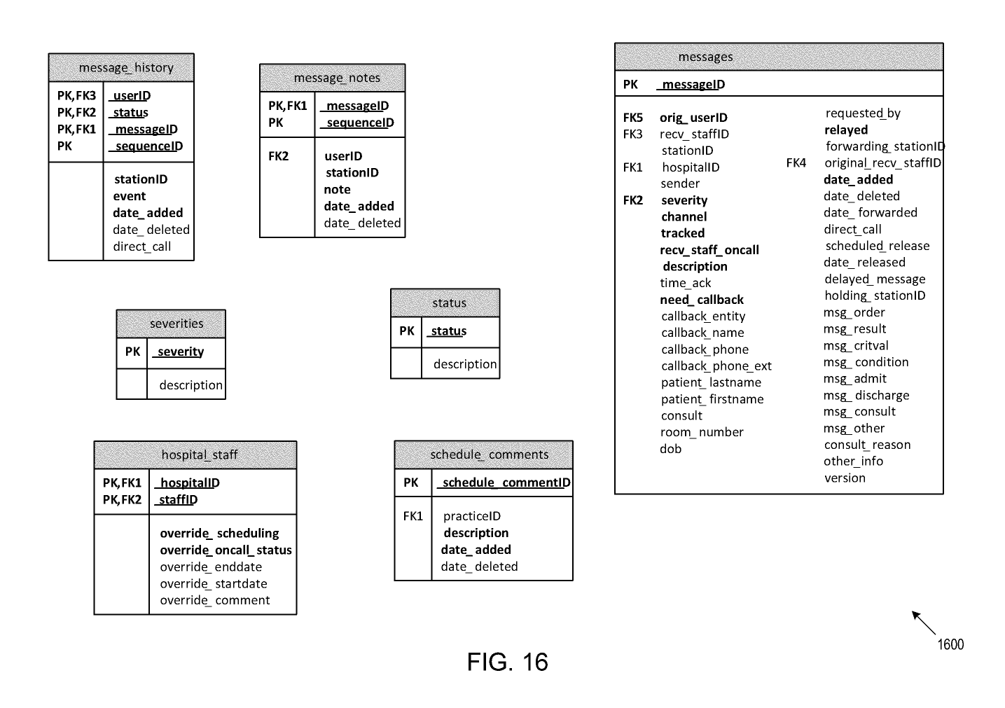

FIG. 13 shows a database schema with entity relationships used by the LMS. FIGS. 14, 15, and 16 show tables defined in the database schema used to support the LMS and the smart paging system (SPS). A variety of system data is used to drive the system. Some of the informational entities in the system may include: users; hospitals; physicians; physician specialties; physician-to-hospital affiliations; physician-to-practice affiliations; physician schedules (by hospital); and messages. The database tables used by the system logic found in the database schema may include the following entities (tables or objects): an answering service practices table that joins the answering service and practices tables, the answering services table to define all the answering service properties, practices table to define the physicians practices, specialties table that defines the specialties the physician practices, the hospitals table that defines all the properties for the hospital, multiple user and staff tables that define the users and staff properties, schedule table and message tables to define the schedules and messages used by the system, and a number of intersecting tables that join the various tables using primary and foreign key relationships between the tables.

The system may use a mobile client device (e.g., Smartphone) containing no resident databases, wherein the data, used for operation by the system application logic executed on the mobile device, resides on a central or distributed database (e.g., SQL Server database or cloud based NoSQL database, either or both may be used based on the geographic scope of the users in communications with each other). The system uses web services to retrieve data from the server, and to persist data on the server when configured to do so. Each system user may be pre-assigned a user ID and password. A variety of system data is used to drive the system. Some of the informational entities in the system may include: users; hospitals; physicians; physician specialties; physician-to-hospital affiliations; physician-to-practice affiliations; physician schedules (by hospital); and messages. The database tables used by the system logic found in the database schema may include: an answering service practices table that joins the answering service and practices tables; the answering services table defines all the answering service properties; the practices table defines the physicians practices; the specialties table that defines the specialties the physician practices; the hospitals table that defines all the properties for the hospital, multiple user and staff tables that define the users and staff properties, schedule table and message tables to define the schedules and messages used by the system; and a number of intersecting tables that join the various tables using primary and foreign key relationships between the tables.

The system is designed to improve inter-physician communications by allowing doctors to contact one another directly. The system provides direct physician-to-physician contact using a variety of methods (page, text message, voice call) as assisted by real-time schedules (practice-provided schedules, physician-provided schedule overrides), physician contact preferences (e.g., the call guard) to permit, or restrict contact, allows the physician to override their practice-provided call schedules, alerts answering services and practices when their physicians make schedule changes.

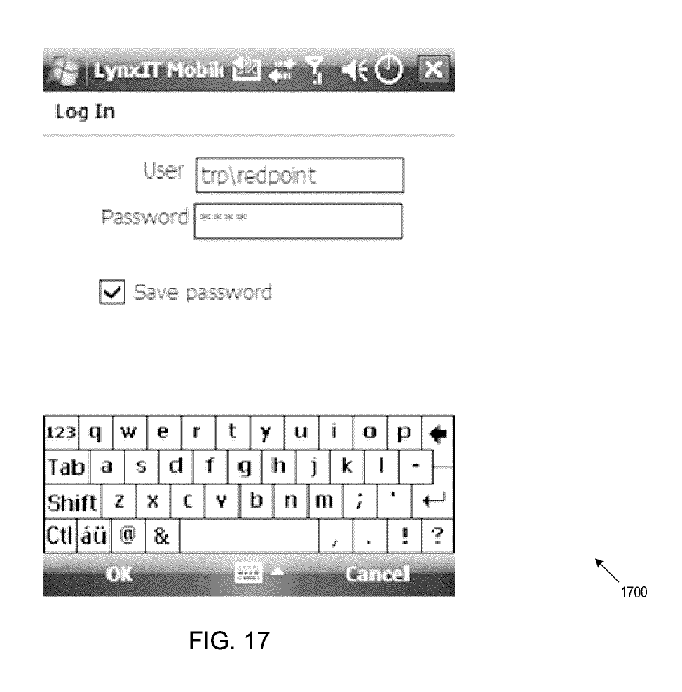

FIG. 17 shows a login page to log into the LMS application with the save password option. The user may their password on the mobile device. To gain access to the system, each user may be pre-assigned a user identifier (ID) and password. Depending on function, the Web methods use a variety of parameters, but the Web methods may require the user and password to include each request in order to provide the context for subsequent processing. For example, the user ID uniquely identifies the physician user, and that user has a fixed set of associated hospital affiliations. The user may be validated by the system logic using a web method GetAuthenticationStatus that returns a value of true to indicate the user is valid, or for an invalid entry, the user name and/or password must be corrected.

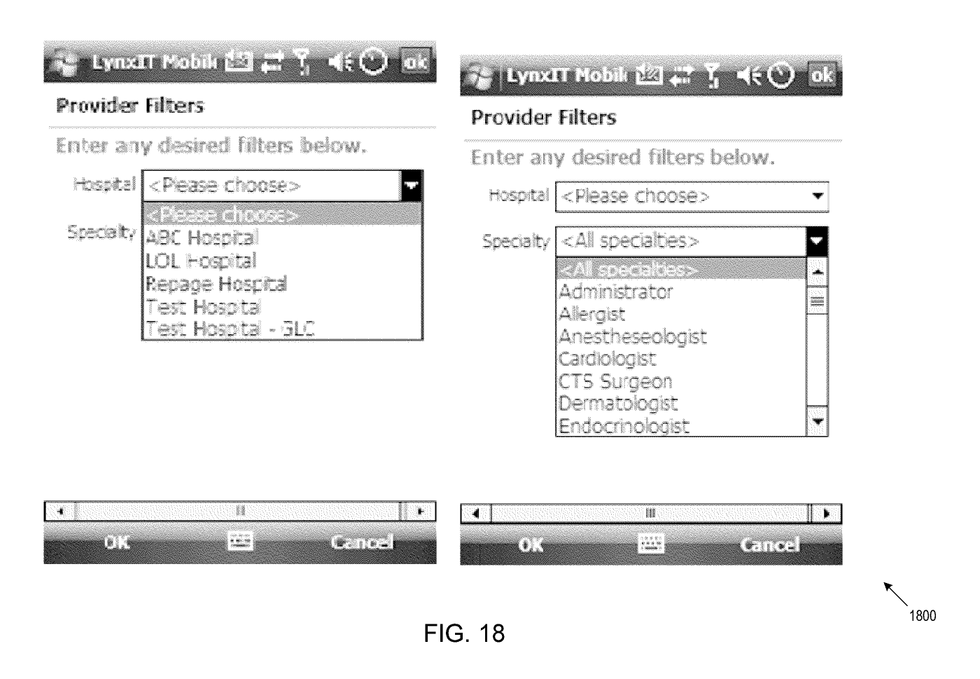

FIG. 18 shows a provider filters page hospital and physician specialty selections that the user interface displays when the system logic invokes web method GetHospitals to populate the list of hospitals that are associated with the user, and invokes web method GetSpecialties to determine the specialty list for the physicians. The system may use the hospital-staff and user tables to determine the hospitals listed, and based on the hospital and specialty filters provided, the provider list may be created.

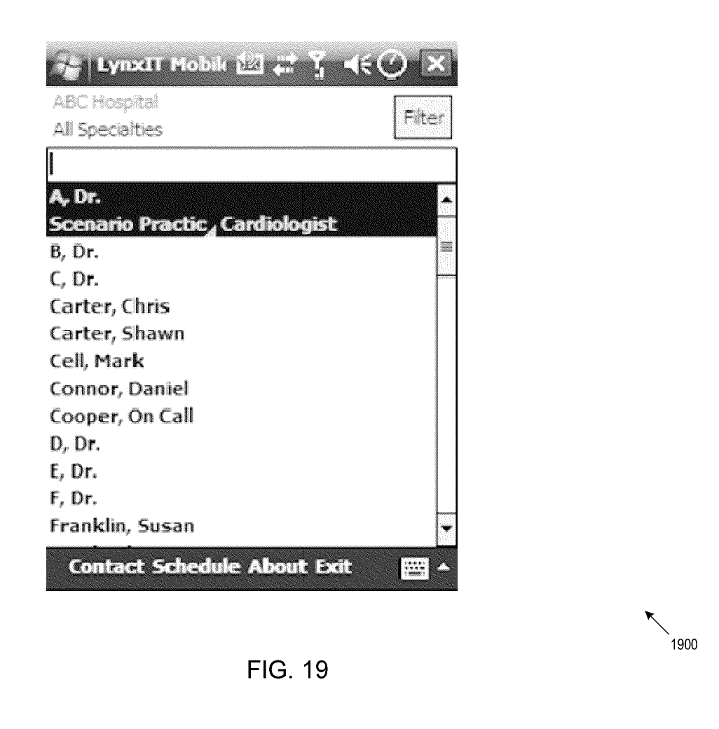

FIG. 19 shows a physician search results page that the user interface displays when the system logic uses the web method GetStaff to populate the list of providers. The system may pass as empty strings and not use practicename, lastname, and firstname as active filters when passed to the Web method.

Table 4 shows call guard rules applied in the order listed.

TABLE 4
Rules applied in the order listed

| | |
|---|---|
| Call guard On | Provider is not available |

Call guard Off

| | |
|---|---|
| Active Available Override | Provider is available |
| Active Unavailable Override | Provider is not available |
| Provider Scheduled | Provider is available |
| Provide Not Scheduled | Provider is not available |

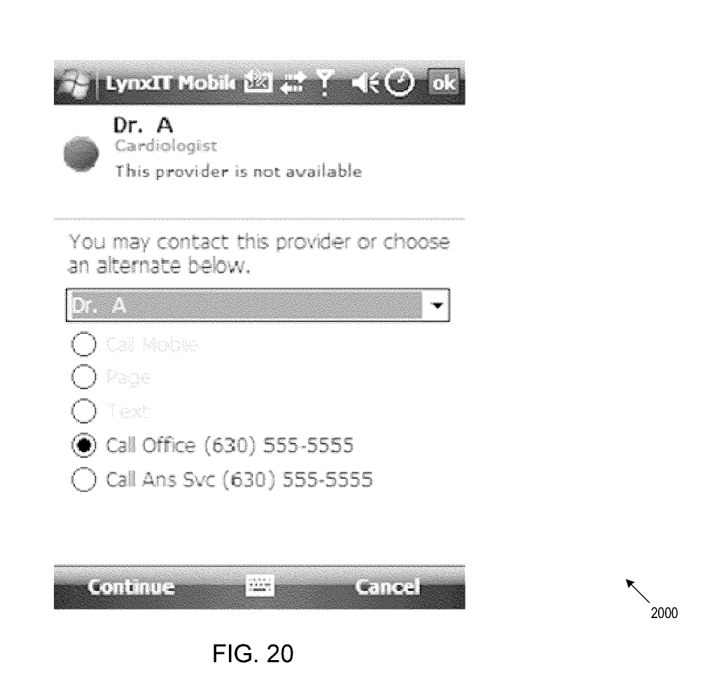

FIG. 20 shows an unavailable physician selected from the search results page that the user interface displays when the contact menu option is selected, the selected physician's contact status is displayed. Depending on the provider's availability, the provider may then be called, paged or texted. The availability shown may indicate: This provider is not available. Either the provider is not currently scheduled at the hospital, has an override in place placing himself off-call, or the Call guard is set for the provider, or This provider is available. Either the physician is currently scheduled at the hospital, has an active available override which places him on-call. Call guard is set to off for this provider. When the contact provider is not available, the system provides a dropdown widget that shows the selected doctor and other available doctors in the same practice, and the Office and Answering Service numbers are available because the provider is not available. The user may contact the office or the answering service for this provider, but may not contact he physician directly. Even though this doctor is not available, another physician in the practice may be listed in the dropdown list to identify another available physician.

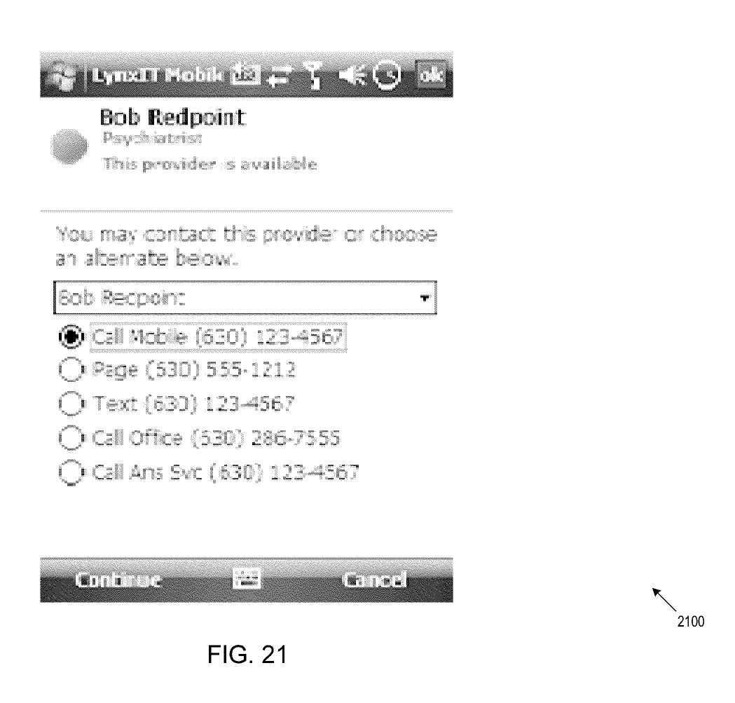

FIG. 21 shows an available physician selected from the search results page that the user interface displays when the contact provider is available. All contact methods can be used. When the provider is available the physician may be directly contacted via a cellular call, page, or text message. The Office and Answering Service options may be available as well.

The system may use web method GetStaffForPracticeAtHospital to determine who the staff members are for the practice and whether the staff members are on call at the current time. When the user elects to contact a provider, the server logs the contact using Web Method LogContactWithHospital. The logging is used to provide administrative statistics about physician communications made using the system. In the Web Method invocation, the channel_code indicates the contact method: CALL—cellular phone call; ANS—call to the provider's answering service; and/or NPG—numeric page to provider's pager; or any combination of contact methods.

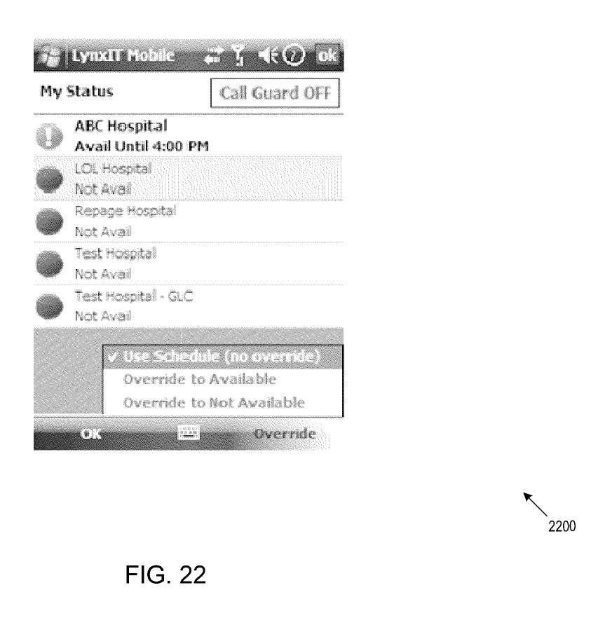

FIG. 22 shows a physician's my status page status and the use schedule option selected that displays the state of the user's Call guard setting (on or off), state of the user's availability at the user's affiliated hospitals. The Status screen also provides information about any overrides that are in place for the hospitals, and allows the user to put an override in place.

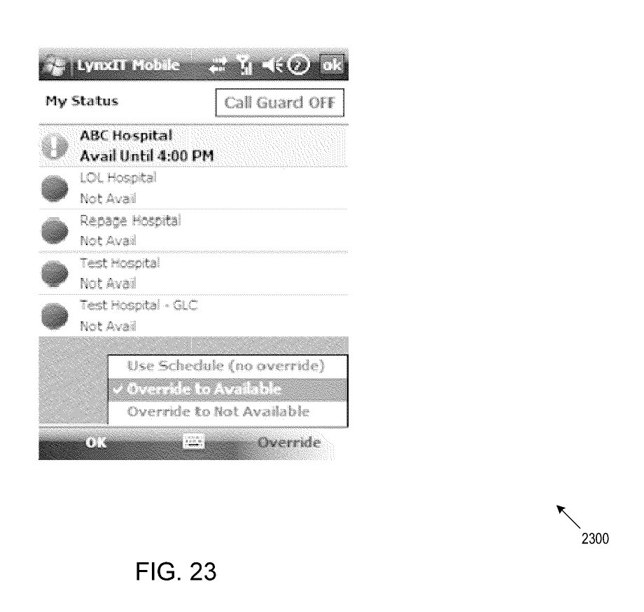

FIG. 23 shows a physician's ‘my status’ page with ‘override to available’ selected, and is active. For example, ABC Hospital (the exclamation mark indicates the override is active). The green circle indicates the physician is available (on-call) for the hospital shown.

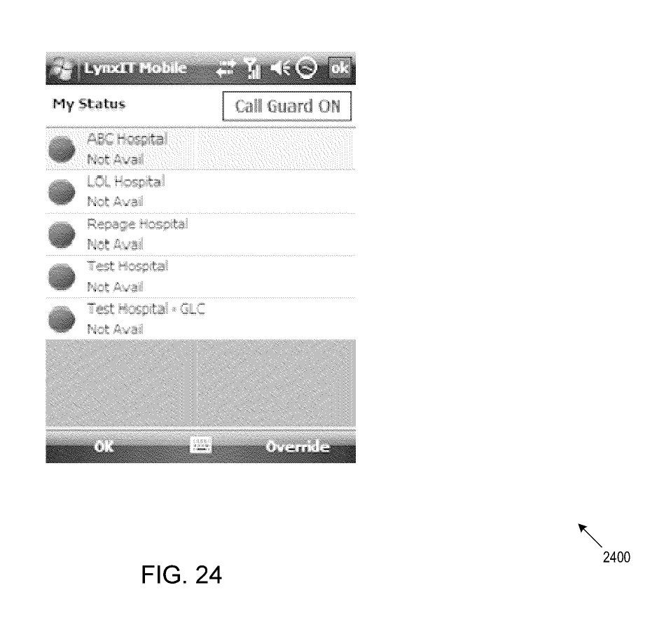

FIG. 24 shows a physician's my status page with call guard option on, when the call guard ON indicates a physician cannot be directly contacted. The Call guard setting determines whether a physician can be directly contacted by other physicians (via cellular call, page, or text message) or anyone else, as configured by the physician. The call guard setting applies to hospitals associated with the physician.

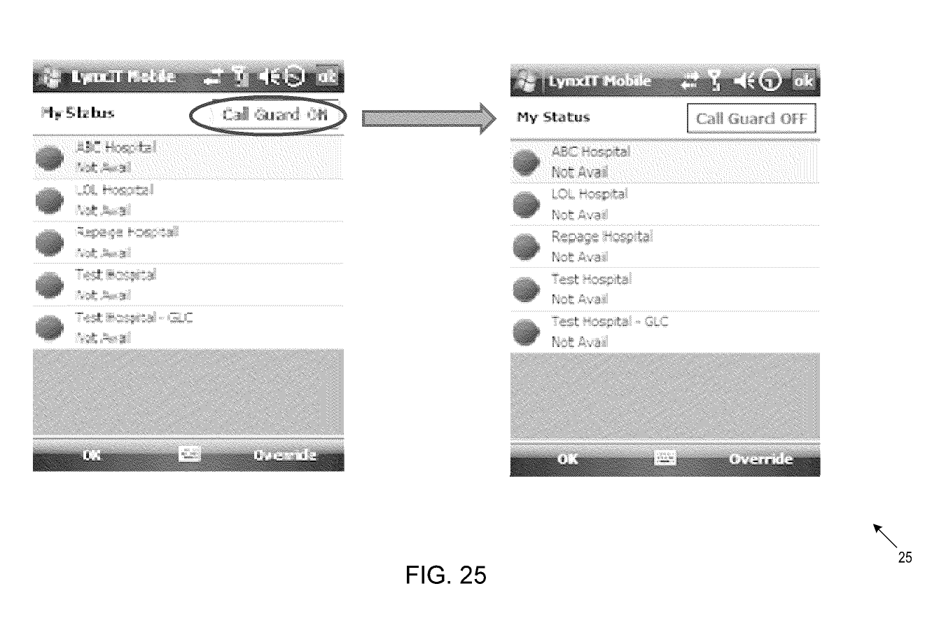

FIG. 25 shows a physician's my status page when the call guard option is toggled from on to off. The status screen when the Call guard setting toggles using the Call guard button at the top right of the mobile device screen. Web Methods GetCallGuard and SetCallGuard are used to retrieve and set the Call guard setting. Web Method UpdateHospitalOnCallStatusPracticeLocalTimeWithComment is used to set or remove a schedule override. When a schedule override is stored or removed, an email alert is sent to the answering service associated with the practice and to the practice. A voice call is also made to the answering service's priority number when one is configured for the answering service.

Schedule alerts are intended to notify the answering service and the practice office when a mobile user has put a schedule override in place (or when a mobile user has removed a schedule override). Both the practice and the answering service receive email alerts. A computerized telephone notification (voice call) may also occur for the answering service. The answering_service_practices table defines the relationship between answering services and practices, and each answering service may have multiple practices associated (e.g., 1-to-many relationship).

Table 5 shows the system events and configurable actions.

TABLE 5
Mobile Schedule Alerts

| | Actions | | |
|---|---|---|---|
| Event | Email Practice | Email Ans Svc | Voice Call Ans Svc |
| LynxIT Mobile | Y | Y | Y |
| Override Occurred | (when email | (when email | (when email sent |
| from Mobile Device | address | address | to ans svc |
| | configured | configured | AND priority |
| | for practice) | for ans svc) | phone number |
| | | | available ) |
| LynxIT Mobile | Y | Y | Y |
| Override Occurred | | | |
| from Web Interface | | | |

The system may be configured to ensure that email schedule alerts are processed in a timely manner by the answering service, SPS may make a computerized call to the answering service when the system sends an email alert. Answering services typically have a “priority number” which bypasses automated phone trees and similar systems. When configured for the answering service, SPS will use the priority number for the phone notification. When the priority number is not configured, no phone notification will occur.

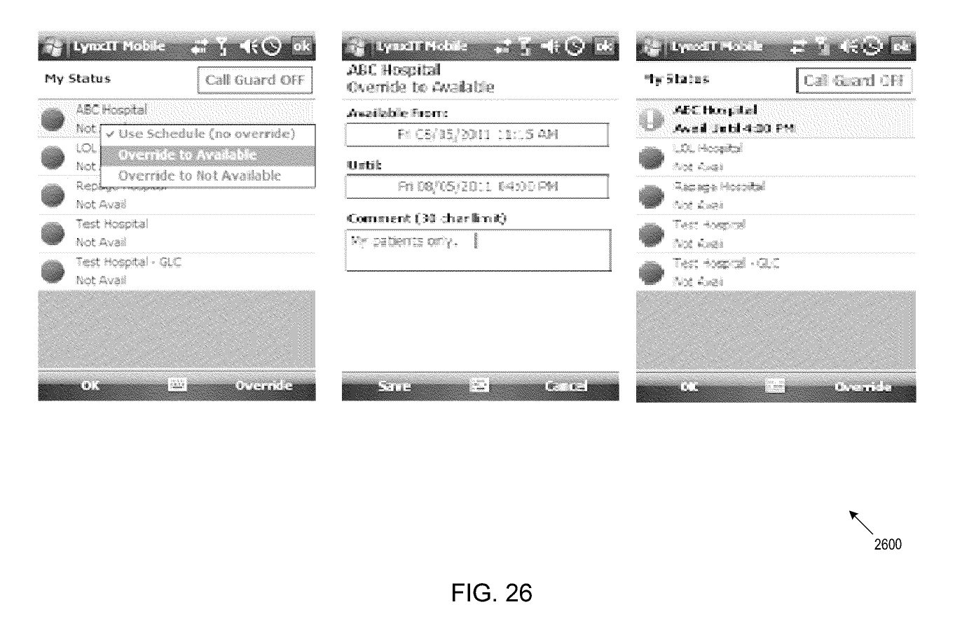

FIG. 26 shows a physician's ‘my status’ page override selection and resulting ‘my status’ page. The screens show how an available override may be set in Windows™ Mobile. The override was put in place on Aug. 8, 2011 at 11:15, so the override shown is active until 4:00 PM. A schedule override is a concept whereby doctors may override their normal practice schedule. The LMS provides two types of overrides: Available override: 1) Physician is available for call, even when his standard practice schedule does not have him on-call; and 2) unavailable override where a physician is not available for call, even when his standard practice schedule has him on-call. Each override has a start-time and end-time associated. In the case of the available override, the physician may supply a comment that clarifies the nature of his availability. An override is active when the current time is later than or equal to the start time and less than the end time of the override.

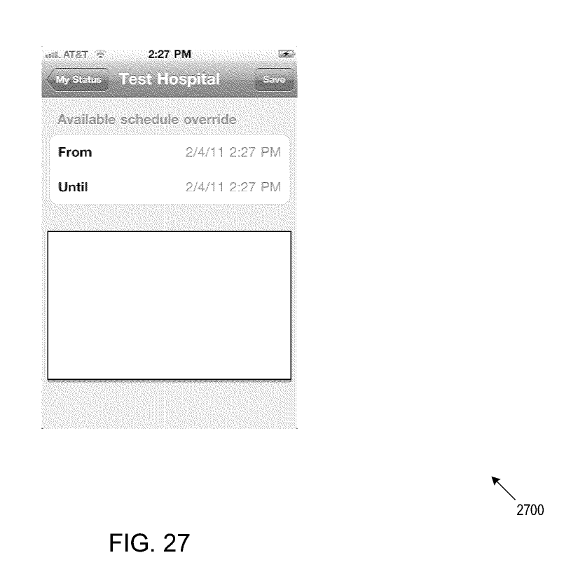

FIG. 27 shows an ‘available schedule override’ page with comment field. The user (physician) may include a comment associated with schedule override, and allow the user to specify a comment of up to 30 characters in length as part of the “create schedule override” payload. The LMS displays the “Comment” label and text area when the user is performing an “Override to available” action. Optionally, the LMS is configurable to present or not present the comments field when the user overrides to not-available status.

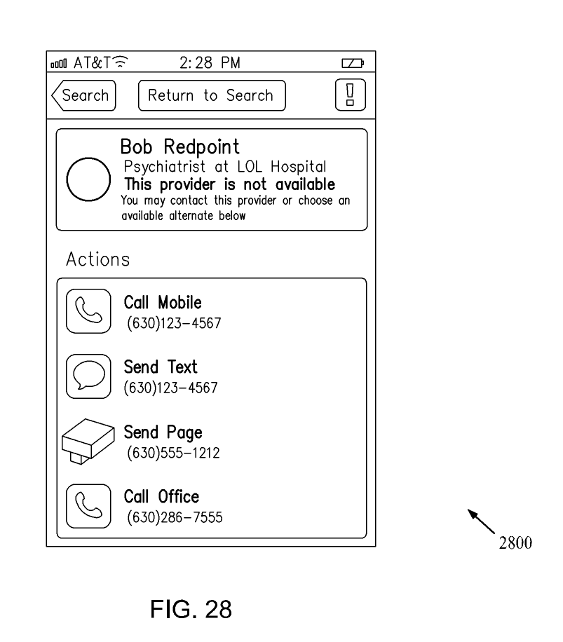

FIG. 28 shows a selected unavailable physician's contact information page selected from the search results list. The LMS, using a web service, presents the On Doc Details page, when the doc is available due to a “make me available” schedule override. The On Doc Details page shows comments entered along with that override, where regular-schedule comments may appear. The mobile client receives updates to the application automatically. The LMS web service selects the comment based on configurable preferences identified by the user and or the administrator or both, and includes the comment in the current message structure. In other words, the comment received from the web service supplying the doctor details could be a regular-schedule comment or an override comment; the mobile client won't care, and will just display what it receives.

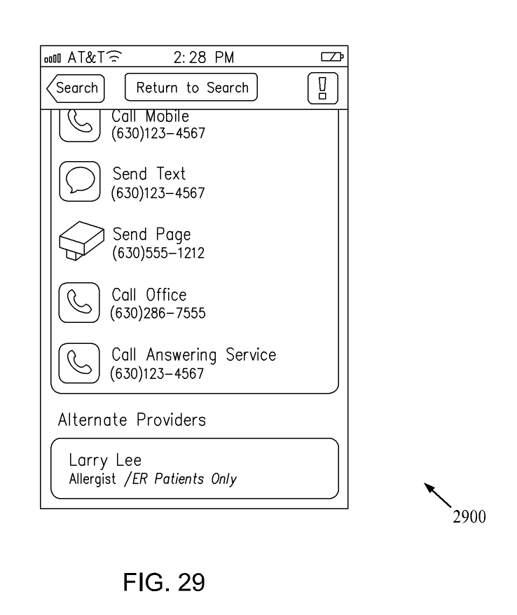

FIG. 29 shows an alternative physician for selection on the selected unavailable physician's contact information page. The LMS, using a web service, presents alternate providers and comments in the mobile user interface (UI). The logic in the LMS web service supplies the features and updates to the mobile client, and selects the correct comment and presents the comment in the field in the message.

The call guard option provides a feature in the LynxIT Mobile application that hides contact information (and contact initiation UI widgets) for personal contact options (e.g., office and answering service numbers will not be affected) when a doctor is unavailable. The call guard option allows the user to suppress personal contact options. For example, on pages that display provider status and contact options (e.g., call, text, page, etc.), when a provider is unavailable and has the Call guard feature enabled, the LMS excludes the Call Mobile, Send Page and Send Text options from the UI. The LMS logic for suppressing personal contact options may be implemented on the server-side of the LMS configuration. The contact numbers displayed on the provider details screens come from data provided for each provider in search results, as displayed in the initial page of the application, from data authentication sources. The LMS may use contact numbers for the users retrieved from a web service GetStaffListForPracticeAtHospital that identifies accessible user authentication sources and retrieves user information. Table 6 shows the web service call for GetStaffListForPracticeAtHospital.

TABLE 6
A web service GetStaffListForPracticeAtHospital

WebInvoke(Method = “POST”, UriTemplate =
“hospital/{hospitalid}/practice/{practiceid}/specialty/{specialtyid}/
staff/{staffID}”)]
[OperationContract]
Contacts GetStaffListForPracticeAtHospital(string hospitalid, string
practiceid, string specialtyid, string staffID, User userCredentials);

The GetStaffListForPracticeAtHospital service retrieves all available doctors in a given practice (which we use to populate the Alternate Providers). The GetStaffListForPracticeAtHospital service always include the doctor whose ID is passed in the staffID parameter, and all available practice members in the practice identified by the practiceID parameter. The LMS includes the contact information (e.g., phone numbers) for each provider returned by the GetStaffListForPracticeAtHospital service. When the LMS populates the provider details page and adds contact options, the LMS uses the phone numbers returned for the selected physician in the result set from the GetStaffListForPracticeAtHospital service, (or optionally uses the phone numbers returned by the service in combination with the numbers provided in the original search result set).

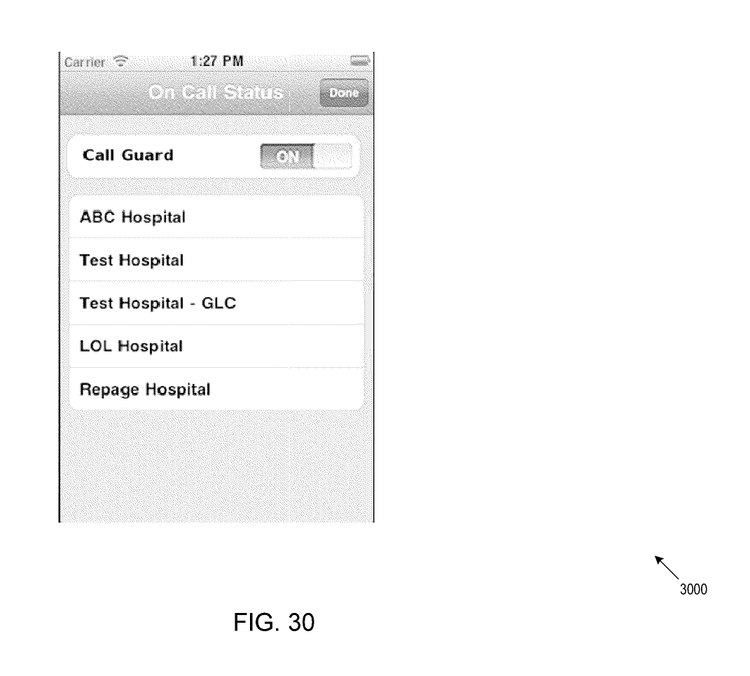

FIG. 30 shows a physician's on-call status with call guard on. The LMS, using a web service, provides a user (provider/physician) to enable/disable the user's call guard. For example, a provider may wish to leave their personal contact options enabled in the LynxIT Mobile application even when the user is unavailable. The LMS provides configurable settings to turn on or off particular call guard behavior. The LMS displays the call guard setting to a provider with a visual indicator (e.g., a check box or appropriate platform-specific widget used to convey a binary setting. For example, on the iPhone platform the on/off slider). The UI widget for the setting to the top of the My Status page. Before displaying the My Status page, the LMS calls a GetCallGuard web service, and sets the UI widget based on the value returned from GetCallGuard before rendering the My Status page. When the user modifies the state of the UI widget (e.g., slides the slider to the other position, or checks/unchecks a check box), the LMS logic may initiate a call to the SetCallGuard web service, and passes the SetCallGuard web service a settings value derived from the new state of the widget in the UI. Filtering based on the CallGuard value may be handled on the server.

Table 7 shows a list of application programming interfaces (APIs) the LMS uses.

TABLE 7
Service API's:

[WebInvoke(Method = “POST”, UriTemplate=“get/callguard”)]
[OperationContract]bool GetCallGuard(User userCredentials);
[WebInvoke(Method = “POST”, UriTemplate=“set/callguard/{callguard}”)]
[OperationContract]void SetCallGuard(string CallGuard,
User userCredentials);

Table 8 shows the GetStaffListForPracticeAtHospital method to support Web operations.

TABLE 8
GetStaffListForPracticeAtHospital web method

```
      [WebInvoke(Method = “POST”, UriTemplate =
“hospital/{hospitalid}/practice/{practiceid}/specialty/{specialtyid}/staff/
{staffID}”)]
  [OperationContract]
    Contacts GetStaffListForPracticeAtHospital(string hospitalid, string
practiceid, string specialtyid, string staffID, User userCredentials);
  public Contacts GetStaffListForPracticeAtHospital(DataSet data)
  {
  var_rv = new Contacts(new List<Contact>( ));
  when (!IsEmptyOrNull(data))
  {
    foreach (DataRow dr in data.Tables[0].Rows)
    {
      _rv.Add(new Contact
      {
        CellNumber = dr[“cellnumber”].ToString( ),
        Comment = dr[“comment”].ToString( ),
        OfficeNumber = dr[“officenumber”]ToString( ),
        PagerNumber = dr[“pagernumber”].ToString( ),
        SpecialtyName = dr[“specialty_name”]ToString( ),
        StaffName = dr[“staffname”].ToString( ),
        StaffId = dr[“staffid”].ToInt(0),
        OnCall = (bool)dr[“oncall”]
      });
    }
  }
  return_rv;
}
```

The GetStaffListForPracticeAtHospital method returns a list of Contact objects. The GetStaffListForPracticeAtHospital method returns all the available physicians and the information for the provided staffID (e.g., in the same practice). The row associated with staffID may be represented once in the returned data (e.g., either with OnCall=true or OnCall=false, where the other rows are guaranteed to have OnCall=true).

Table 9 shows methods configured to persist the state of the LMS application.

TABLE 9
Methods configured to persist the state of the LMS application

```
[WebInvoke(Method = “POST”, UriTemplate=“get/callguard”)]
  [OperationContract]
  bool GetCallGuard(User userCredentials);
  [WebInvoke(Method = “POST”, UriTemplate=“set/callguard/
  {callguard}”)]
  [OperationContract]
  void SetCallGuard(string callguard, User userCredentials);
```

Table 10 shows the UpdateOnCallStatus method used by the LMS application.

TABLE 10
UpdateOnCallStatus method

```
public class UpdateOnCallStatus
{
  public int HospitalId { get; set; }
  public bool OnCallStatus { get; set; }
  public string Comment { get; set; }
  public DateTime? OverrideEnddate { get; set; }
  public DateTime? OverrideStartdate { get; set; }
  public bool ScheduleStatus { get; set; }
  public User UserCredentials { get; set; }
}
```

Table 11—use of UpdateHospitalOnCallStatus method

TABLE 11
use of UpdateHospitalOnCallStatus method

```
  [WebInvoke(Method = “POST”, UriTemplate = “oncallstatus/update”)]
  [OperationContract]
    OnCallStatuses UpdateHospitalOnCallStatus(UpdateOnCallStatus
onCallStatus);
```

The LynxIT system enables a first provider to communicate and request a consult with a second provider regarding a medical procedure or service, where the second provider and alternative providers practice the medical procedure or service. A set of service codes correspond to the medical procedure and service. The user interface logic presents the set of service codes for the medical procedure or service when the availability status for the second provider indicates that the second provider is available. The user interface logic presents an availability status for the second provider, and when the availability status for the second provider indicates that the second provider is unavailable, displays an availability status for each of the alternative providers, where the second provider and the alternative providers practice the medical procedure or service. The user interface logic selects the set of service codes, and when the availability status for the second provider indicates that the second provider is unavailable, selects one of the alternative providers displayed as available according to the request by the first provider. The user interface logic may presents content from the content sponsors and/or context sponsors for the set of service codes to the providers.

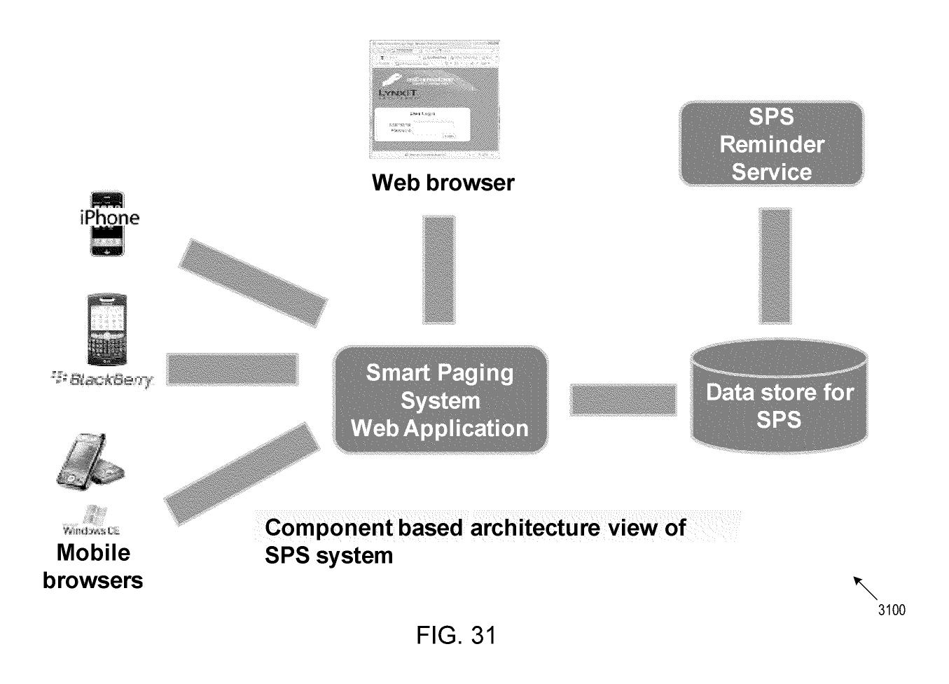

FIG. 31 shows a smart paging system (SPS) configuration. The LynxIT Mobile Solution may interface to a paging system (e.g., the smart paging system (SPS) or other paging system) to provide a cost-effective web-based application that creates an efficient, structured paging environment for healthcare professionals at every level, including clerks, nurses, ancillary services and discharge planners.

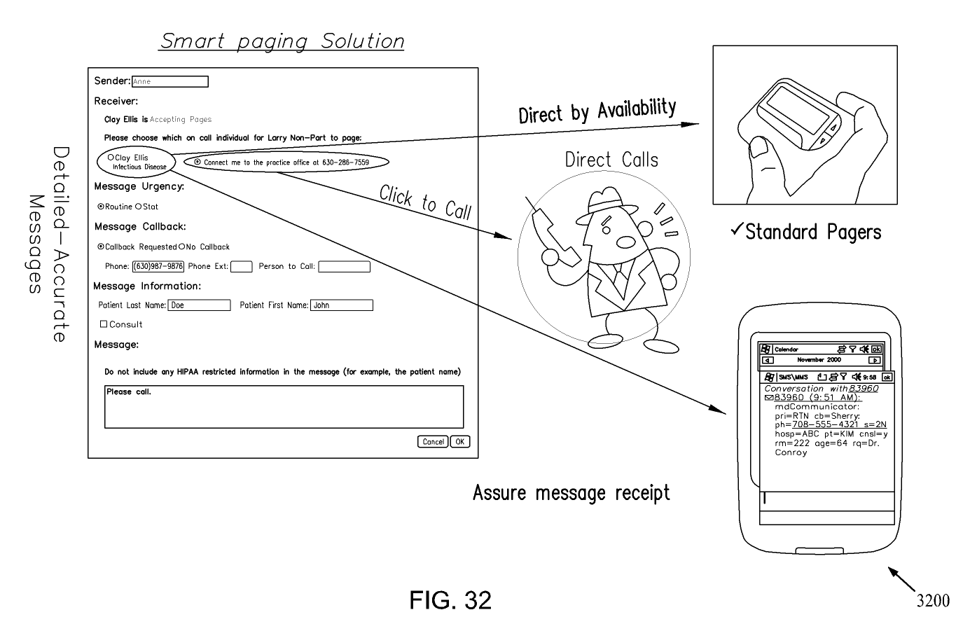

FIG. 32 shows SPS communications features. The smart paging system transmits pertinent information to healthcare providers based on the healthcare provider's schedule. The smart paging system provides direct hospital to physician communications, funds and delivers message page based on available position or on-call alternative, tracks and confirms message receipt, provides quality metric reporting including physician compliance for returning calls and physician response time for returning calls, the system works with standard cell phones and pagers, and provides risk management by documenting and time stamping all communication. The smart paging system protects nursing, clerical, and physician time, decreases communication errors, improves nursing satisfaction, facilitates timely decision-making, configurable to bypass answering services, provides quality metric reporting, and decreases patient length of stay. Smart paging system uses standardized formatting messages, includes schedule of all registered physicians, smart paging system checks for the availability of a physician, and uses a configurable method of communications including for example standard paging pagers and SMS messages with cell phones. Smart paging system provides a dashboard to track messages so that all that callbacks may be monitored, receipt of messages may be confirmed, and quality metrics collected and analyzed, and thereby reduce risk.

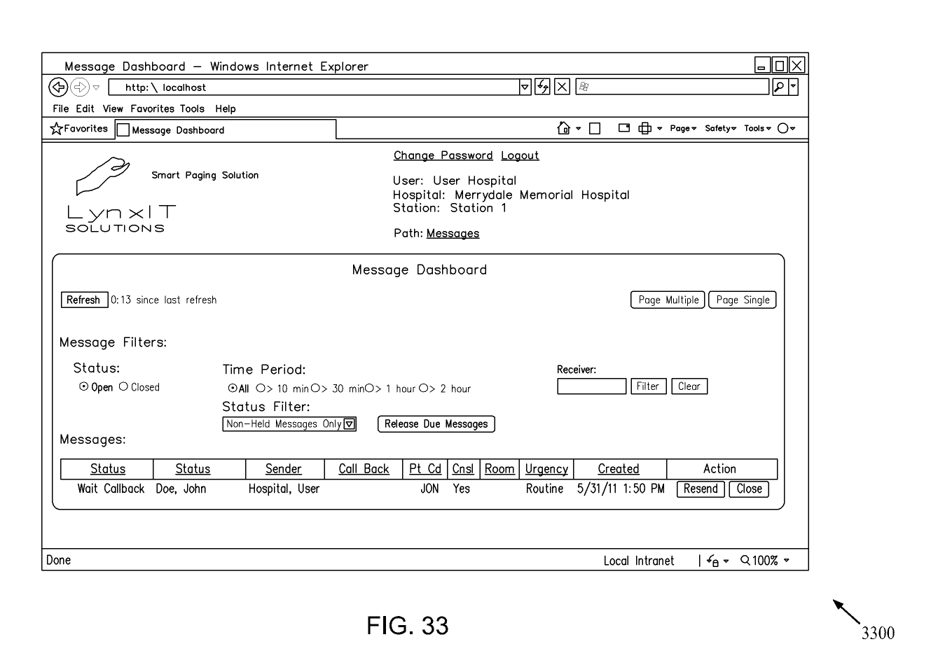

FIG. 33 shows a user's (Health facility) message dashboard that each user may have access to the user's own dashboard to manage paging system messages.

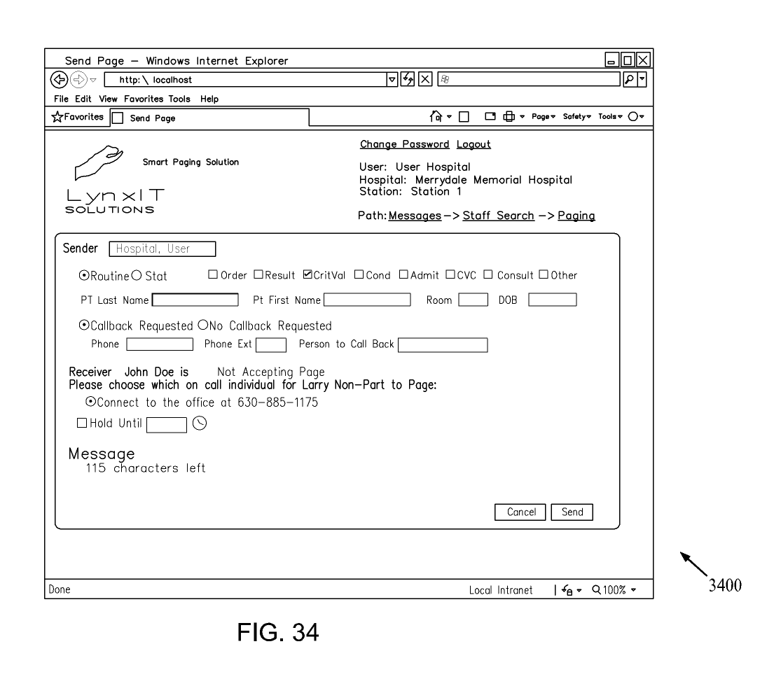

FIG. 34 shows a ‘create message’ page for a physician not accepting pages, where field information required for the message creation is the highlighted (e.g., yellow or some other visual indicator) by a configurable rule that imposes the requirement for the information in order to create the message. The paging provides standardization with radio buttons so messages automatically include content for texting and paging so that LMS presents users with fields to select message content that is standardized that LMS outputs as text.

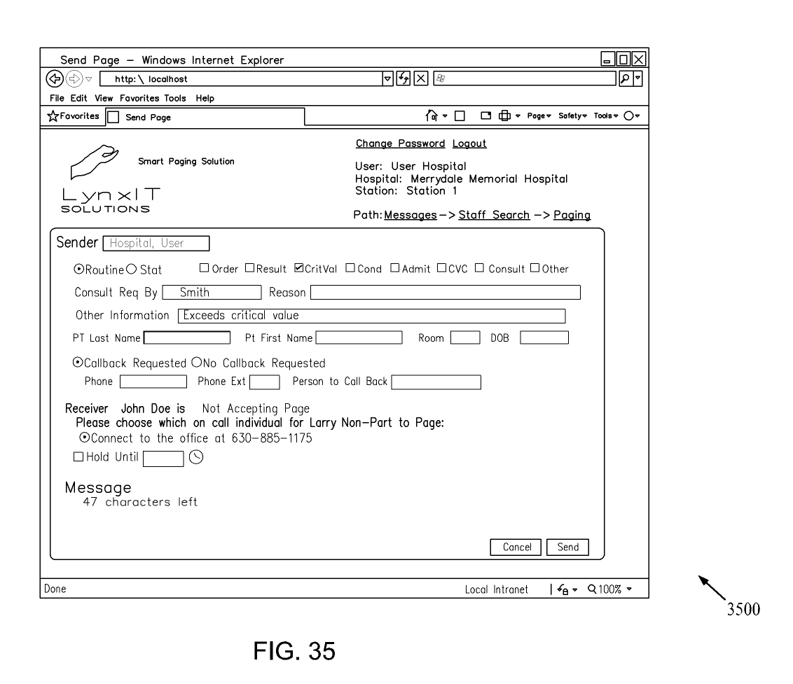

FIG. 35 shows a ‘create message’ page for a consult, where field information required for the message creation is the highlighted (e.g., yellow or some other visual indicator) by a configurable rule that imposes the requirement for the information in order to create the message.

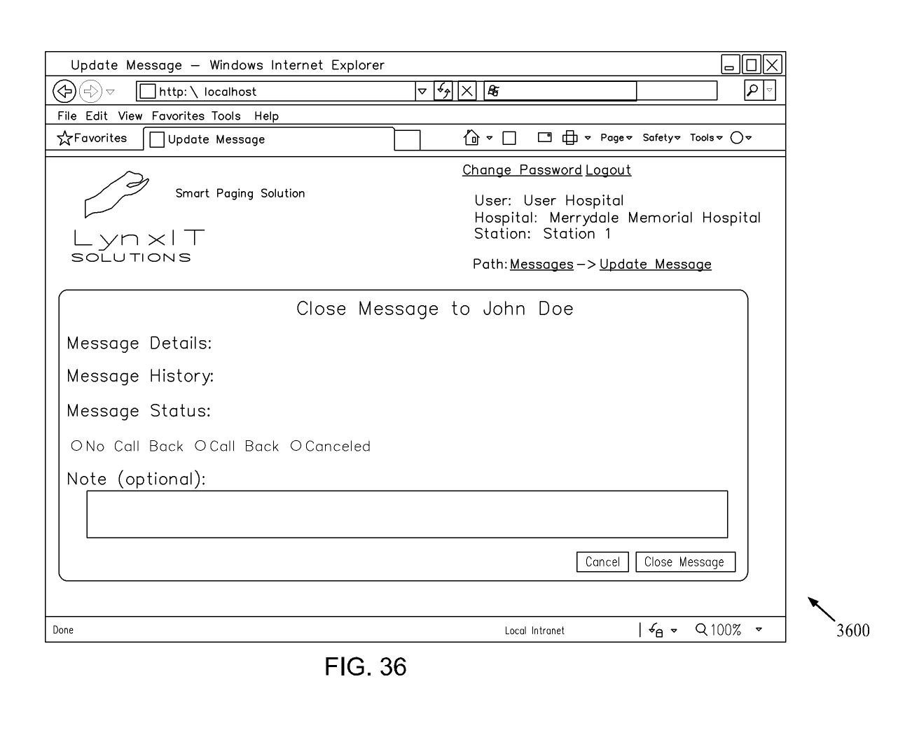

FIG. 36 shows a ‘close message’ page for a message confirmed closed by the user based on configurable rules.

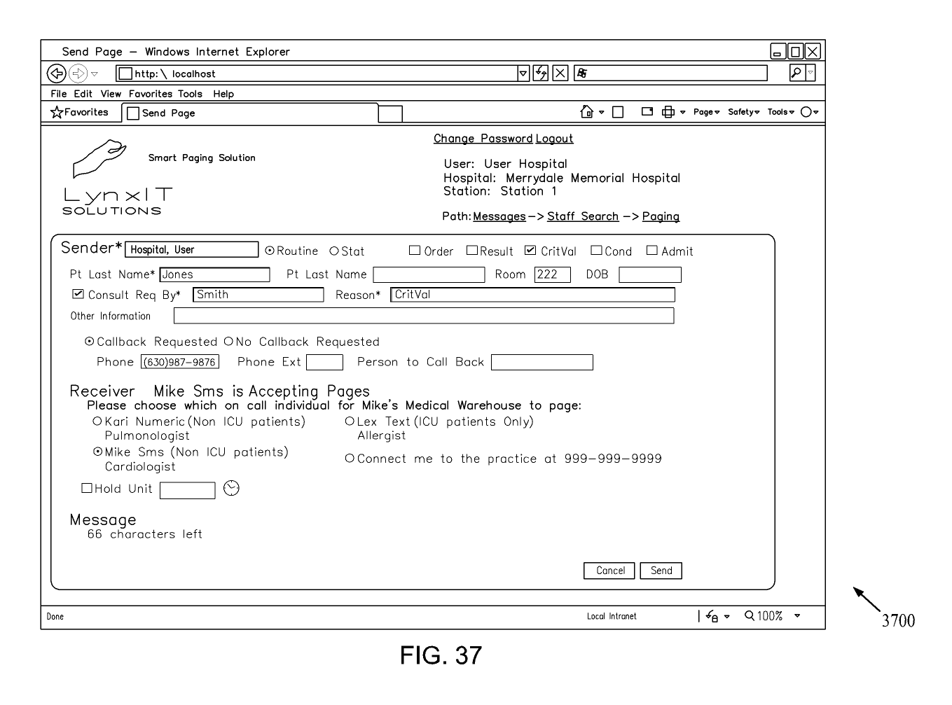

FIG. 37 shows a ‘create message’ page for a physician accepting pages, where field information required for the message creation is the highlighted.

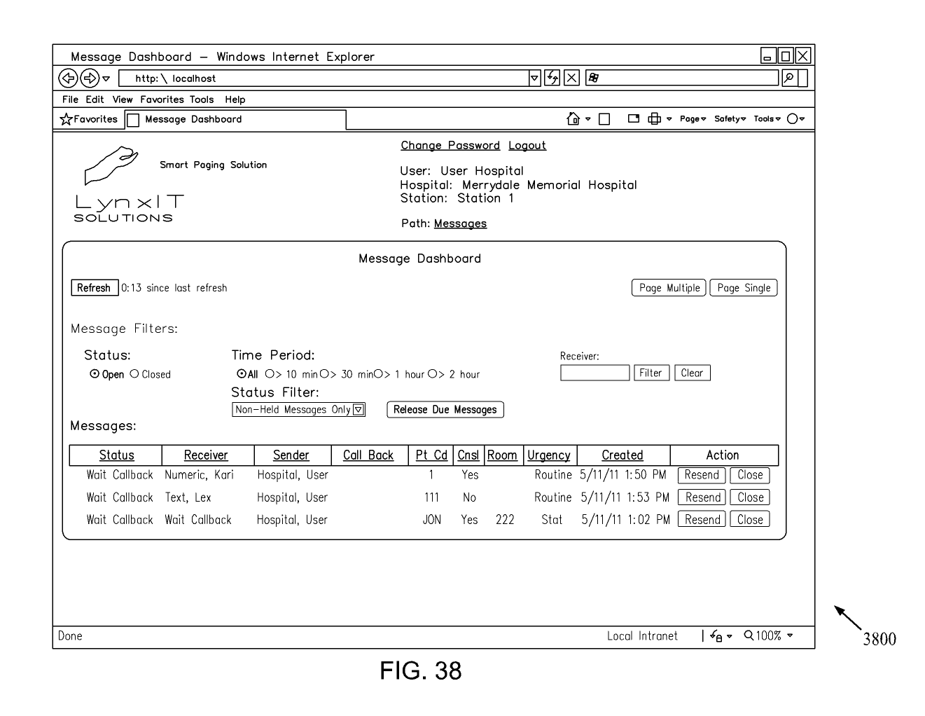

FIG. 38 shows a user's (Health facility) message dashboard. The callback phone number “always required” list is used to release a held message to a person with a numeric pager. Since the callback number is present (e.g., pre-populated with the nurse station number).

Depending on the function, the Web methods used by the LMS and SPS use a variety of parameters, but the Web methods require the user and password to be included in the request. The user and password included in the request provides context for subsequent processing. For example, the user identifier (ID) uniquely identifies the physician (user), and identifies whether he user has a fixed set of associated entities (e.g., hospital affiliations and other health medical facilities).

Table 12 shows web services used by the LynxIT Mobile system.

TABLE 12
Web Services Used by LynxIT Mobile

```
public string GetSystemVersion( ):
tt_MDC_GetMobileUserFromUsername
public bool GetAuthenticationStatus(string user, string password, int
devtype)
public DataSet GetHospitalOnCallStatus(string user, string password, int
devtype, int hospitalID)
public DataSet GetHospitalOnCallStatusPracticeLocalTime(string user,
string password, int devtype, int hospitalID)
public DataSet GetHospitals(string user, string password, int devtype)
public DataSet GetOnCallStaffForPracticeAtHospital(string user, string
password, int devtype, int practiceID, int hospitalID, int specialtyID)
public DataSet GetStaffForPracticeAtHospital(string user, string password,
int devtype, int practiceID, int hospitalID, int specialtyID, int staffID)
public bool GetCallGuard(string user, string password, int devtype)
public void SetCallGuard(string user, string password, int devtype, bool
callGuard)
public void ReassignScheduleBlocks(string user, string password, int
devtype, DataTable ScheduleReassignments)
public void ReassignScheduleBlock(string user, string password, int
devtype, int scheduleID, int toStaffID)
public DataSet GetSeverities(string user, string password, int devtype)
public DataSet GetSpecialties(string user, string password, int devtype)
public DataSet GetStaff(string user, string password, int devtype, int
hospitalID, int specialtyID, string practicename, string lastname, string
firstname)
public DataSet GetScheduleForTimePeriod(string user, string password, int
devtype, DateTime start_time, DateTime stop_time)
public DataSet GetScheduleForUtcTimePeriod(string user, string password,
int devtype, string start_time_utc, string stop_time_utc)
public DataSet GetStatus(string user, string password, int devtype, string
sw_version)
public void LogContact(string user, string password, int devtype, int
recv_staffID, string channel_code, bool recv_staff_oncall)
public void LogContactWithHospital(string user, string password, int
devtype, int recv_staffID, string channel_code, bool recv_staff_oncall, int
hospitalID)
public DataSet UpdateHospitalOnCallStatus(string user, string password,
int devtype, int hospitalID, bool override_scheduling,
  bool override_oncall_status, DateTime? override_starttimestamp,
DateTime? override_stoptimestamp)
public DataSet UpdateHospitalOnCallStatusWithComment(string user,
string password, int devtype, int hospitalID, bool override_scheduling,
  bool override_oncall_status, DateTime? override_starttimestamp,
DateTime? override_stoptimestamp, string override_comment)
public DataSet UpdateHospitalOnCallStatusPracticeLocalTime(string user,
string password, int devtype, int hospitalID, bool override_scheduling,
  bool override_oncall_status, DateTime? override_starttimestamp,
DateTime? override_stoptimestamp)
public DataSet
UpdateHospitalOnCallStatusPracticeLocalTimeWithComment(string user,
string password, int devtype, int hospitalID, bool override_scheduling,
  bool override_oncall_status, DateTime? override_starttimestamp,
DateTime? override_stoptimestamp, string override_comment)
public DataSet GetAllPractices(string user, string password, int devtype)
public DataSet GetDoctorUsersForPractice(string user, string password, int
devtype, int practiceID)
public DataSet GetStaffForPracticeAtHospitalByUsername(string user,
string password, int devtype,
  int hospID)
```

The subject matter described in this specification can be implemented as a method or on a device, including in the form of one or more computer program products. The subject matter described in the specification can be implemented in a data signal or on a machine readable medium, where the medium may be tangible or non-transitory and may be embodied in one or more information carriers, such as a CD-ROM, a DVD-ROM, a semiconductor memory, or a hard disk. Such computer program products may cause a data processing apparatus to perform one or more operations described in the specification.

In addition, subject matter described in the specification can also be implemented as a system including a processor, and a memory coupled to the processor. The memory may store or encode one or more programs to cause the processor to perform one or more of the methods described in the specification when the processor executes the program instructions. Further subject matter described in the specification can be implemented using various machines.

A number of implementations have been described. Nevertheless, it will be understood that various modification may be made without departing from the spirit and scope of the invention. Accordingly, other implementations are within the scope of the following claims.

What is claimed is:

1. A method for providing physician to physician communication comprising:
registering a plurality of users, including a first user and a second user, to use an application accessible on a network;
receiving a user registration identifier for the users;
validating the user registration identifiers;
retrieving entity identifiers for entities where the users is authorized;
storing each of the entity identifiers that correspond to the validated users;
receiving a first user communication status selection for the first user;
receiving a communications request from the second user requesting to communicate with the first user;
comparing the communications request from the second user with the communication status selection of the first user; and
when the communications request satisfies the communication status selection, providing a communications method to use between the first user and the second user, according to the communication status selection of the first user.

2. The method of claim 1, wherein the registration identifier identifies a license to practice and one or more plurality of specializations for the user; and
when the communications request of the second user does not satisfy the communication status selection of the first user, providing the second user an alternative user to select for communications, wherein the alternative user configured a communication status selection compatible with the communications request of the second user.

3. The method of claim 1, wherein validating the registration identifier comprises:
authenticating the user registration identifier by comparing the registration identifier with one of a plurality of authentication sources accessible through the network; and
communicating a validation result indicator that indicates whether the registration identifier is valid.

4. The method of claim 1, wherein the identifiers are retrieved from a plurality of accessible staff directories for hospitals and other healthcare facilities, and wherein the entities comprise hospitals and other healthcare facilities.

5. The method of claim 1, wherein storing each of the identifiers for the entities that correspond to the validated user, includes storing the identifier on a mobile device used by the user.

6. The method of claim 5, wherein the mobile device is configured to communicate audio and visual communications.

7. The method of claim 1, wherein the user communication status selection indicates the type of communication the user is willing to receive, including: text messaging; an email; phone call.

8. The method of claim 1, wherein the user communication status selection indicates the type of communication the user is willing to receive based on the role of the requester requesting the communications.

9. A product for providing physician to physician communication, the product comprising:
a computer readable memory with processor executable instructions stored thereon, wherein the instructions when executed by the processor cause the processor to:
register a plurality of users, including a first user and a second user, to use an application accessible on a network;
receive a user registration identifier for the users;
validate the user registration identifiers;
retrieve entity identifiers for entities where the users are licensed to practice;
store each of the entity identifiers that correspond to the validated users;
receive a first user communication status selection for the first user;
receive a communications request from the second user requesting to communicate with the first user;
compare the communications request from the second user with the communication status selection of the first user; and
when the communications request satisfies the communication status selection, provide a communications method to use between the first user and the second user, according to the communication status selection of the first user.

10. The product of claim 9, wherein the registration identifier identifies a license to practice and one or more plurality of specializations for the user; and
when the communications request of the second user does not satisfy the communication status selection of the first user, providing the second user an alternative user to select for communications, wherein the alternative user configured a communication status selection compatible with the communications request of the second user.

11. The product of claim 9, wherein validating the registration identifier comprises:
authenticating the user registration identifier by comparing the registration identifier with one of a plurality of authentication sources accessible through the network; and
communicating a validation result indicator that indicates whether the registration identifier is valid.

12. The product of claim 9, wherein the identifiers are retrieved from a plurality of accessible staff directories for hospitals and other healthcare facilities, and wherein the entities comprise hospitals and other healthcare facilities.

13. The product of claim 9, wherein storing each of the identifiers for the entities that correspond to the validated user, includes storing the identifier on a mobile device used by the user.

14. The product of claim 13, wherein the mobile device is configured to communicate audio and visual communications.

15. The product of claim 9, wherein the user communication status selection indicates the type of communication the user is willing to receive, including: text messaging; an email; phone call.

16. The product of claim 9, wherein the user communication status selection indicates the type of communication the user is willing to receive based on the role of the requester requesting the communications.

17. A system for providing physician to physician communication, the system connected to a network comprising:
a memory coupled to a processor, the memory comprising:
registration requests for a plurality of users, including a first user and a second user, to use an application accessible on the network;
a user registration identifier for the users;
user registration identifiers validation status;
entity identifiers for entities where the users are licensed to practice;
a first user communication status selection for the first user;
a communications request from the second user requesting to communicate with the first user;
instructions executable by the processor that when executed by the processor cause the processor to:
retrieve the entity identifiers for entities;
validate the user registration identifiers;
compare the communications request from the second user with the communication status selection of the first user; and
when the communications request satisfies the communication status selection, provide a communications method to use between the first user and the second user, according to the communication status selection of the first user.

18. The system of claim 17, wherein the registration identifier identifies a license to practice and one or more plurality of specializations for the user; and
when the communications request of the second user does not satisfy the communication status selection of the first user, providing the second user an alternative user to select for communications, wherein the alternative user configured a communication status selection compatible with the communications request of the second user.

19. The system of claim 17, wherein validating the registration identifier comprises:
authenticating the user registration identifier by comparing the registration identifier with one of a plurality of authentication sources accessible through the network; and
communicating a validation result indicator that indicates whether the registration identifier is valid.

20. The system of claim 17, wherein the identifiers are retrieved from a plurality of accessible staff directories for hospitals and other healthcare facilities, and wherein the entities comprise hospitals and other healthcare facilities.

21. The system of claim 17, wherein storing each of the identifiers for the entities that correspond to the validated user, includes storing the identifier on a mobile device used by the user.

22. The system of claim 21, wherein the mobile device is configured to communicate audio and visual communications.

23. The system of claim 17, wherein the user communication status selection indicates the type of communication the user is willing to receive, including: text messaging; an email; phone call.

24. The system of claim 17, wherein the user communication status selection indicates the type of communication the user is willing to receive based on the role of the requester requesting the communications.
